(19) United States
(12) Patent Application Publication
(10) Pub. No.: US 2011/0276423 A1
(43) Pub. Date: Nov. 10, 2011

(54) Systems and Methods for Content Communication

(75) Inventor: Daniel L. Davidson, Miami Beach, FL (US)

(73) Assignee: ONENEWS CORPORATION, Miami Beach, FL (US)

(21) Appl. No.: 13/100,865

(22) Filed: May 4, 2011

Related U.S. Application Data
(63) Continuation-in-part of application No. 12/186,213, filed on Aug. 5, 2008.
(60) Provisional application No. 60/954,484, filed on Aug. 7, 2007.
(60) Provisional application No. 60/985,326, filed on Nov. 5, 2007.

(51) Int. Cl. G06Q 30/00; G06Q 10/00

(52) U.S. Cl. 705/26.1; 705/1.1

(57) ABSTRACT

A system, a method, and a computer program product for content communication are disclosed. A first content is received by a first party. At least one second party configured to obtain a second content related to the first content is determined. Based on at least one first criterion, at least one second party for obtaining the second content is selected. At least one second party is contacted and requested to obtain the second content. The second content is obtained by the first party.

### CROSS-REFERENCE TO RELATED APPLICATIONS

The present application claims priority to and is a continuation-in-part of U.S. patent application Ser. No. 12/186,213 to Davidson, filed Aug. 5, 2008, and entitled “Method and System for On-Line Content Acquisition and Distribution”, which claims priority to U.S. Provisional Patent Application No. 60/954,484 to Davidson, filed Aug. 7, 2007, entitled “Method and System for On-Line Content Acquisition and Distribution” and to U.S. Provisional Patent Application No. 60/985,326 to Davidson, filed Nov. 5, 2007, entitled “Method and System for On-Line Content Acquisition and Distribution”, and incorporates disclosures of these applications herein by reference in their entireties.

### TECHNICAL FIELD

The subject matter described herein relates to data processing and in particular, to providing content communication and distribution.

### BACKGROUND

The Internet has become the most widely accepted mechanism for file and information sharing. The Internet's accessibility and affordability have allowed individuals of all backgrounds to share electronic media content. Further, this accessibility and affordability continues to improve. Simultaneously, advancements in electronic devices have allowed many of these individuals to generate more and more electronic media. Because of the portability of electronic devices such as cell phones and digital cameras, individuals are readily equipped to capture images, video, and sound. Moreover, the quality of such content has improved thereby increasing the use of portable electronic devices.

Interestingly, individuals who have generated or captured electronic media (referred to herein as “originators”) have demonstrated a desire to share their content. This is evident by the rising popularity of such entities as YouTube® and MySpace®. For example, originators can upload their captured images, videos, and sound recordings onto YouTube® for others around the world to view. Often the con tent shared has little or no monetary value, and is shared with no expectation of receiving compensation. However, some of the shared content does have monetary value.

In particular, news organizations may be interested in some of the content uploaded and shared on sites such as YouTube®. An example of such content may be images for a corresponding news story. Because of the tremendous number of cell phones equipped with image capture capabilities, it is more likely that a person equipped with such an electronic device, rather than a professional news reporter, will be at the scene of a news story when the “action” takes place. Thus, news reporters often miss the valuable “action” images they seek, and instead, are left with the less valuable images of the aftermath. Hence, news organizations are in need of a means to interact with the originators.

While newspapers have seen a decline in distribution and readership, more attention is being shifted to cable, broadcast, internet, blogs, mobile devices and other vehicles for delivery of rich video content. Irrespective of medium, the distribution of content related to news and current events is a multi-billion dollar industry and is here to stay. By all measures the news media is becoming considerably more robust as consumers are growing accustomed to, and expect more from, broadband connections, mobile device access, high resolution images, faster connects, richer data, greater search-ability, and other factors.

The news media is one of the most rapidly evolving e-commerce industries as a result of rapidly advancing mobile technologies—supporting broadcast quality image capture over high speed wireless, e.g. third generation data networks. Unfortunately, the benefits of these changes have not been realized by the broadcasting industry as a whole, due to the absence of a central platform for collection and distribution of this new source of content.

Today, media organizations are required to dispatch expensive electronic, news gathering crews (ENG) to breaking news events using expensive camera decks, satellite trucks and costly labor in order to capture time-critical content. Due to cost cutting decisions, news organizations have had to decrease the number of ENG teams in the field, and have become increasingly reliant on third party news feeds and alternative methods of acquiring content.

Traditional news broadcasters are maintaining their profits by also cutting back on the size of their newsrooms, while simultaneously demanding that their ever decreasing pool of reporters produce more with less. Compounding the problem has been the immediate need of newsrooms to make substantial capital investments in converting their internal newsroom computer systems (NRCS) from tape based linear systems to nonlinear digital systems. Overall broadcast journalism today has been focused on disseminating the news, not in collecting it.

As news bureau staffs get smaller, the statistical likelihood of a camera equipped reporting team being at the right place at the right, time becomes ever less probable. Therefore, traditional news crews, by the time they reach the event, are forced to broadcast images after the event has occurred. Citizen journalism has changed the face of news dramatically as media giants now become increasingly reliant on the public for low or zero-cost content of the action as compared with the high-cost content of the aftermath.

While individuals with cell phones now number 3.3 billion, and individuals with camera equipped mobile devices continue to displace news crews as the primary first reporters of news events worldwide, there currently exists no enabling infrastructure or central repository to acquire, classify, tag, manage, authenticate, distribute and monetize this rapidly increasing amount of captured content.

Therefore, citizen reporters find themselves haphazardly providing content at no cost to local news stations, and with no formal infrastructure in place, they do so with little or no possibility of compensation, protection of digital rights or crediting system.

While individuals today currently have the ability to upload through primitive on-line channels their content at no-cost to individual news organizations, they have missed their true opportunity to maximize the potential value of their contribution. This is because of the limited market exposure of calling one to only a few news organizations, negotiations between the parties, documentation of agreements to assign the content, negotiations between the parties, documentation of agreements to assign the content, the delay of delivery of time sensitive content, and having no business entity capable of maximizing content value through a content distribution network.

Further, there is currently no method for the news organizations to easily locate the originators and exchange media or information. Rather, the originators have to contact each news organization separately to of or sell their content. This process is time-consuming and many originators are not aware of how to contact potential buyers. Social networking sites and repositories lime YouTube® do not offer a solution to these problems. These sites do not provide a means for the originator to receive compensation for sharing content. Furthermore, these sites do not organize content in a manner that is easy for news organizations to analyze. For example, YouTube® does not organize content by region, so that a local television station can find content relevant to its region.

Another deficiency of these sites is that there is no efficient means for an originator to transfer media directly from a portable electronic device in a manner that is financially beneficial to the originator. Currently, originators first transfer their con tent to personal computers before uploading the content to YouTube® and similar centralized systems. This process is not only inconvenient, but also may reduce the value of the content. Today's society favors the most immediate information, and thus, the sooner the information can reach the consumer the more valuable that information becomes.

It is therefore desirable to have a system and method that allows a content originator the opportunity to offer captured content for sale to interested purchasers in a manner that expediently connects the originator with the prospective purchaser.

### SUMMARY

In some implementations, the current subject matter relates to a method. A first content can be received by a first party. At least one second party configured to obtain a second content related to the first content can be determined. At least one second party for obtaining the second content can be selected based on at least one first criterion. At least one second party can be contacted and requested to obtain the second content. The second content can be obtained by the first party. The at least one of the receiving, the determining, the selecting, the contacting and the requesting, and the obtaining can be performed on at least one processor.

In some implementations, the current subject matter can include one or more of the following optional features. The determining can include determining the at least one second party based on at least one second criterion. The at least one second criterion can include a geographic location of the at least one second party. The at least one first criterion can include at least one of the following: the geographic location of the at least one second party, a skill of the at least one second party, a history of obtaining content by the at least one second party for the first party, an equipment used by the at least one second party to obtain content for the first party, at least one interest of the at least one second party, and at least one affiliation of the at least one second party. The obtaining the second content can include obtaining the second content by at least one second party. The method can also include determining at least one third party configured to obtain a third content related to the first content, selecting, based on at least one third criterion, the at least one third party for obtaining the third content, contacting the at least one third party and requesting the at least one third party to obtain the third content, and obtaining the third content by the first party. The obtaining the second content can be performed substantially simultaneously in time with the receiving of the first content. The method can also include determining whether to accept the requesting to obtain the second content by the at least one second party, accepting, based on the determining, the requesting to obtain the second content and obtaining the second content by the at least one second party, otherwise, declining, based on the determining, the requesting to obtain the second content. The method can include determining a compensation of the second party for obtaining the second content based at least on the obtained second content and compensating the at least one second party for obtaining the second content. The method can further include providing at least one fourth content together with the obtained second content by the at least one second party to the first party, wherein the at least one fourth content is associated with the second content. In some implementations, the method can include contacting the at least one second party after the at least one second party provided the second content to the first party and requesting the at least one second party to provide the at least one fourth content to the first party. The second content can include at least one of the following: a video recording, an audio recording, an audio/video recording, a photograph, a text transcription, and a multimedia document. The at least one fourth content includes a description of the second content, wherein the description can include at least one of the following: a video recording, an audio recording, an audio/video recording, a photograph, a text transcription, a voice-to-text transcription, a text-to-voice transcription, an Internet document identified by at least one universal resource locator, a computer program, a multimedia document, and a combination of the above. The method can also include determining a future fifth content that can be obtained based on the received first content and at least one sixth content configured to be received by the first party and requesting the at least one second party to obtain the future fifth content. In some implementations, the method can include automatically generating a request to the at least one second party to obtain second content based on at least the received first content.

Articles are also described that comprise a tangibly embodied machine-readable medium embodying instructions that, when performed, cause one or more machines (e.g., computers, etc.) to result in operations described herein. Similarly, computer systems are also described that can include a processor and a memory coupled to the processor. The memory can include one or more programs that cause the processor to perform one or more of the operations described herein.

The details of one or more variations of the subject matter described herein are set forth in the accompanying drawings and the description below. Other features and advantages of the subject matter described herein will be apparent from the description and drawings, and from the claims.

Articles are also described that comprise a tangibly embodied machine-readable medium embodying instructions that, when performed, cause one or more machines (e.g., computers, etc.) to result in operations described herein. Similarly, computer systems are also described that can include a processor and a memory coupled to the processor. The memory can include one or more programs that cause the processor to perform one or more of the operations described herein.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates an exemplary on-line content distribution system, according to some implementations of the current subject matter.

FIG. 2 illustrates an exemplary interaction between originators, a central repository, consumers and enterprise organizations, according to some implementations of the current subject matter.

FIG. 3 is a block diagram illustrating exemplary components including image capture and image categorization modules, according to some implementations of the current subject matter.

FIG. 4 is a flowchart illustrating an exemplary image capture process, according to some implementations of the current subject matter.

FIG. 5 is a flowchart illustrating an exemplary image categorization process, according to some implementations of the current subject matter.

FIG. 6 illustrates an exemplary result of a third party query for specific newsworthy information, according to some implementations of the current subject matter.

FIG. 7a is a flowchart illustrating an exemplary media buyer registration process, according to some implementations of the current subject matter.

FIGS. 7h-7d illustrate exemplary user interfaces for media buyer registration process, according to some implementations of the current subject matter.

FIGS. 8a-8d illustrate exemplary user interfaces for media buyer management of content submissions, according to some implementations of the current subject matter.

FIG. 8e is a flowchart illustrating an exemplary method for managing content submissions by a media buyer, according to some implementations of the current subject matter.

FIG. 9a is a flowchart illustrating an exemplary method for channel creation for content submissions, according to some implementations of the current subject matter.

FIGS. 9b-9c illustrate exemplary user interfaces for management of channels by media buyer, according to some implementations of the current subject matter.

FIG. 9d is a flowchart illustrating an exemplary method for channel filtering, according to some implementations of the current subject matter.

FIG. 10a is a flow chart illustrating an exemplary method for assignment creation for submission of content, according to some implementations of the current subject matter.

FIGS. 10b-10f illustrate exemplary user interfaces for management of assignments by media buyer, according to some implementations of the current subject matter.

FIG. 11 is a flowchart illustrating an exemplary method for filtering assignments, according to some implementations of the current subject matter.

FIG. 12a is a flowchart illustrating an exemplary method for reporter registration, according to some implementations of the current subject matter.

FIGS. 12b-12d illustrate exemplary user interfaces associated with reporter registration, according to some implementations of the current subject matter.

FIG. 13 is a flowchart illustrating an exemplary method for reporter assignment selection, according to some implementations of the current subject matter.

FIG. 14 is a flowchart illustrating an exemplary method for uploading, of content by a reporter, according to some implementations of the current subject matter.

FIG. 15 is a flowchart illustrating an exemplary method for managing content submitted by reporters, according to some implementations of the current subject matter.

FIG. 16 illustrates an exemplary system, according to some implementations of the current subject matter.

FIG. 17 illustrates an exemplary method, according to some implementations of the current subject matter.

### DETAILED DESCRIPTION

To address these and potentially other deficiencies of currently available solutions, one or more implementations of the current subject matter provide methods, systems, articles or manufacture, and the like that can, among other possible advantages, provide systems and methods for providing systems, methods, and computer program products for content communication.

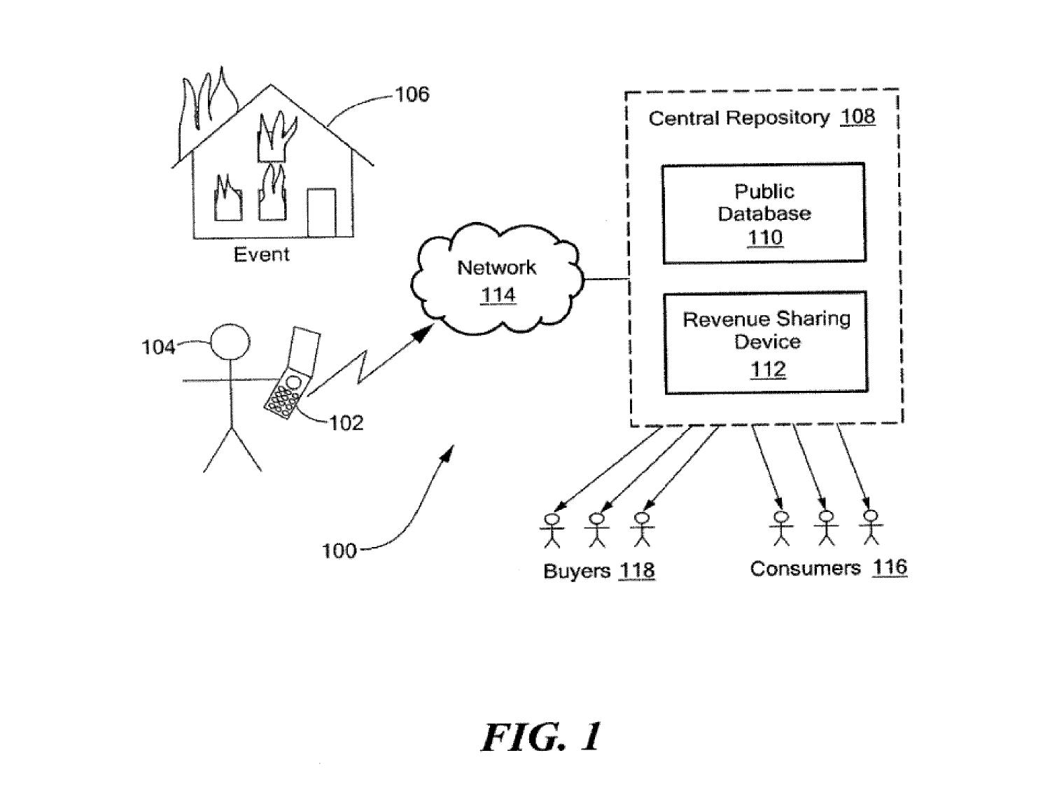

Referring now to the drawing figures in which like reference designators refer to like elements, there is shown in FIG. 1 a diagram of an exemplary system constructed in accordance with the principles of the current subject matter and designated generally as “100”. On-line distribution system 100 provides for the distribution of electronic media captured by individuals using a portable electronic device 102. Electronic media, such as images, video, sound recordings, etc. are captured by individuals using portable electronic devices, such as cell phones, digital cameras, video cameras, etc. Individuals capturing such media are herein interchangeably referred to as “originators” or “subscribers” 104.

In some implementations of the current subject matter, system 100 contemplates the use of a dedicated mobile device 102 that works seamlessly within system 100 to facilitate the capture and uploading of content to a central repository 108. This device would be similar to a mobile phone with a camera but would have higher quality image capture device, audio capture device, built in system for rapid tagging of content, GPS to provide (exact) location and orientation of device (vector to magnetic dipole—ex. 45 degrees North East) and other data pertinent to an event 106 (Which could have application in crime forensics, weather forecasting, etc.) and to help provide proof of authenticity and verifiability of location, date, and other variables.

Originators 104 can capture still images, video, audio, or some combination of all three. The captured content could be, for example, a crime such as a bank robbery or a drug deal, a sporting event, the sighting of a famous actress, politician, or athlete, traffic at a certain location, the witnessing of a catastrophic event such as a hurricane or tsunami, or an event of national interest such as a State of the Union address or a space shuttle launch.

Originators 104 may upload their electronic media to a central repository 108 accessible via network 114, for example a cellular communication network, or the Internet. Additionally, originators 104 have the option of making the uploaded electronic media free to the public or to submit the electronic media to a revenue sharing device 112. If the originator 104 chooses to submit the electronic data to the revenue sharing device 112, then the electronic media can be made available to potential buyers through one or more purchase methods, discussed below. If the electronic media is purchased, the originator 104 may receive compensation for the purchased media via one or more compensation plans, also discussed below.

Thus, the current subject matter includes a method for on-line distribution of newsworthy media content. The method includes a capturing, an uploading, and a distribution. During capturing, an originator 104 captures electronic media using a portable electronic device 102. It is understood that the electronic media is captured by operating the portable electronic device 102 in its intended manner. Thus, the details on how to capture electronic media are beyond the scope of the current subject matter and are not discussed herein.

During uploading, the originator 104 uploads the captured electronic media from the portable electronic device 102 to a central repository 108. The uploading begins when an originator 104 selects the electronic media desired to be uploaded. The originator 104 then enters the appropriate commands, designed for the portable electronic device 102 in use, so that the electronic media is uploaded. Depending on the electronic device 102 the upload commands may be made by pressing one or more buttons.

During distribution, the electronic media is made accessible to a buyer 118 and/or consumer 116. The events of the distribution depend on whether originator 104 requests compensation for the provided electronic media. If the originator 104 does not intend to be compensated, then the distribution includes placing the electronic media on the network server of repository 108, such that it is accessible to the public. Thus, a consumer 116 may view and/or download the electronic media by opening a web browser, navigating to a designated website, and selecting the desired electronic media. However, if originator 104 desires to be compensated, then the distribution involves downloading the electronic media from the central repository 108 to a buyer 118 or making the electronic media available to buyer 118. Note, that this downloading may be initiated by the buyer 118 or revenue sharing device 112 of repository 108. In an exemplary distribution, the revenue sharing device 112 automatically forwards electronic media to news organizations 118 it believes have an interest in the electronic media. Different originator compensation schemes contemplated by system 100 of the current subject matter are discussed in greater detail below.

Referring to FIG. 1, an on-line media distribution system 100 includes at least one originator 104 with a portable electronic device 102 to record an event 106. A central repository 108 having a public database 110 and a revenue sharing device 112, receive electronic media content over a wired or wireless communications network 114. At least one portable electronic device 102 is coupled to the central repository 108 via network 114, such as the Internet or a telecommunications network (i.e. cellular phone network). It is over this network 114 that electronic media is transferred from the portable electronic device 102 to the central repository 108. The central repository 108 is a database located on a network server, such that it is accessible to third parties via a communication network such as the Internet.

Portable electronic device 102 may be a cell phone, digital camera, video camera, or any portable device capable of capturing electronic media such as images, video, sound recordings, etc. in some implementations, a portable electronic device 102 has at least one button that originator 104 can press to automatically upload electronic media to the central repository 108. For example, it is contemplated that the portable electronic device 102 can be configured with a dedicated button and include programmatic code to allow the portable electronic device 102 to establish a connection with the central repository 108, transfer the electronic media, etc.

In alternate embodiments, the upload can be performed by any input given by the originator 104. For example, an originator 104 may give a voice command or touch a touch-screen to trigger the portable electronic device 102 to upload the captured electronic media. Additionally, the portable electronic device 104 may include other buttons for allowing the originator 104 to input a sale offer, provide comments about the event 106, or to communicate with repository 108 or other third parties. Such buttons may be found in the form of a keypad or touch screen.

Central repository 108 includes processors, memory devices, data storage devices, I/O devices and communication interfaces, along with the necessary software to enable repository 108 to communicate with originators 104 and third party entities over a communication network, receive images and data from image capture devices 108, index these images and present the images to interested third parties on a website where they are accessible over the Internet. Central repository 108 may be controlled by a system administrator that receives subscriptions to system 100 from customers wishing to enjoy the benefits of the news dissemination system of the current subject matter.

As mentioned above, the central repository 108 is a database located on a network server. In some implementations, the central repository 108 is located on a single network server. Alternatively, the central repository 108 may be divided such that it is located on more than one network server. For example, the central repository 108 may be constructed such that its public database 110 is on one network server and its revenue sharing device 112 is on another network server. Among the functions of the central repository 108 are to receive and parse the incoming electronic media, store and categorize the media, and determine whether the incoming electronic media should be stored on the public database 110 or sent to the revenue sharing device 112. This decision to categorize media into public database 110 (where no compensation is sought) or revenue sharing device 112 may be based on the request of originator 104.

If originator 104 decides to share the electronic media with the public for free, then the central repository 108 will forward the data to the public database 110. The public database 110 is a storage medium located on a network server that is globally accessible to the general public via the Internet. The public database 110 also contains a user interface to allow consumers 116 to search and view the electronic media without charge. In an exemplary embodiment, the user interface provides one or more web pages at a designated website. A consumer 116 may access the electronic media by opening a web browser and navigating to the designated website. Once at the website, a consumer 116 may utilize various tools, such as keyword searches, to locate desired media.

Referring to FIG. 1, a sequence of events utilizing the current subject matter may occur as follows: An event 106 occurs that is captured by an originator 104 on the originator's electronic image capture device 102. Event 106 can be any witnessed, heard or sensed event such as, for example, a fire, a burglary, an earthquake, a hurricane, the sighting of a famous athlete or movie star, or the witnessing of a car accident. The originator 104 can then upload the media content from his or her media capture device 102 to central repository 110 via network 114. Once updated, the content can be disseminated to consumers 116 via access to the Internet, or can be disseminated to one or more news agencies, or buyers 118, via an electronic bidding system. If purchased by or licensed to a news organization 118, the originator 104 may be reimbursed by one of a variety of reimbursement plans (discussed in greater detail below).

As another embodiment, an originator 104 who uploads electronic media to public database 110 may agree to transfer ownership of the uploaded media or to license the media to the service provider of the public database 110 such that the service provider can sell or otherwise distribute the electronic media to generate revenue. This revenue may or may not be shared with the originator 104 depending upon the subscription terms.

Thus, utilizing the camera in the originator's image capture device 102, which can be configured with an internal location traction (GPS or cell site triangulation) mechanism, news organizations 118 can issue specific requests for information at certain geographic locations. These specific requests, referred to as BOLO (“Be-On-Look-Out”) requests, can be narrowed to the smallest subgroup possible through the use of user data profile based on geographic territory (zip code, city, etc.), social interests, sports, or other parameters. For example, when an originator 104 registers with repository 108, information about the originator 104 including their work and home address, and alternate addresses such as summer or winter home, is stored in repository 108. News agencies 118 seeking timely news about au event an a specific geographic region can contact repository 108, and, in turn, repository 108 can quickly determine which originators 104 live or work in the requested region. Alternately, repository 108 can receive GPS signals from all registered electronic devices 114 in the requested region. This information will of course be valuable to the requesting news agency 118 if it needs to obtain information quickly about a newsworthy even happening in a specific region.

In some implementations, the potential buyers 118 may be buyers previously registered with system 100, such that they have an account with system 100 that allows for efficient sales transactions. Additionally, registered buyers 118 may be sent electronic media of particular interest to them. For example, if the registered buyer 118 is a San Francisco area news organization, then the revenue sharing device 112 may determine which electronic media is relevant to San Francisco and notify the registered buyer 118. The notification may be performed by forwarding the relevant media or alerting the registered buyer 118 of the content via an email, text message, phone call, etc.

The process of filtering the electronic media for relevant content and notifying registered buyers 118 is performed by a computer processor included in repository 108. This processor may utilize keyword searches, sound recognition, and metadata (e.g., cell phone number) to filter the electronic media into groups. By filtering the electronic media into smaller groups, revenue sharing device 112 can efficiently determine which media is relevant to buyers 118. In other words, the filtering process reduces the amount of time a registered buyer 118 needs to sift through electronic media.

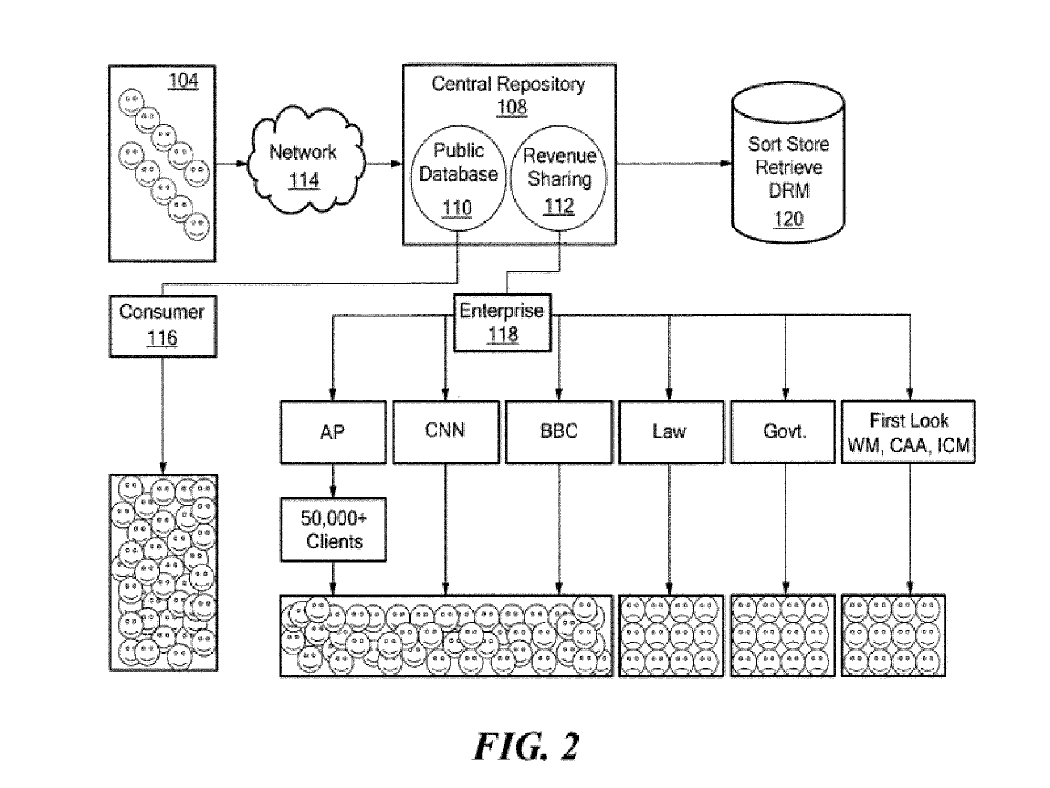

FIG. 2 illustrates the online media distribution system 100 of FIG. 1 in greater detail. One or more content originators 104 may subscribe to a service whereby they can capture electronic media content, upload the media content to central repository 108, and in some instances, be reimbursed for media content captured on their media capture devices 102. Originators 104 can inform repository 108 whether their captured content should be distributed to consumers 116 without compensation to the originator 104 or whether the captured content is to be distributed to one or more news enterprises 118 in return for compensation. If the former, than the uploaded content can be stored in public database 110, if the latter, the content is stored in revenue sharing database 112. In addition to being stored, content in each database can be searched, sorted, retrieved and distributed.

Content in repository 108 can reside in a database 120, where it can be sorted using conventional data sorting algorithms. Enterprise entities 118, which could be, for example, news agencies such as AP, CNN, or BBC, or any commercial, law or government-related agency, can access database 120 in order to search for and obtain news-related media.

In some implementations of the invention, system 100 allows enterprise entities 118 that have registered with system 100 to directly con tact or “ping” originators 104 in order to request content on specific events or focused subject matter, rather than wait for the media content to become available on repository 108. This feature may include a compensation plan that allows originators 104 to receive compensation either directly from the requesting enterprise 118 or indirectly, through repository 108. As an example, enterprise 118 desires information about the sighting of a famous movie star leaving a trendy club in South Beach. Using a location determination mechanism such as Global Positioning System (GPS) or the use of cell site triangulation, the requesting enterprise 118 can receive positioning signals from one or more media capture devices 102 held by originators 104 that are situated within a geographic area near the club. Alternately, enterprise 118 can receive, from repository 108, a listing of data profile information about originators 104, including, for example, each originator's home address, work address, and interests. Using this data, requesting enterprise 118 can then narrow to the smallest subgroup possible the number of available media capture devices 102.

In another example, enterprise 118 may want a “scoop” on the latest happenings at Yankee Stadium in a big game with the Red Sox. By accessing the data profile information about registered originators 104, enterprise 118 can determine which originators are baseball fans, specifically Yankee fans, and live within a certain radius of Yankee stadium. They can then send out text messages to all identified originators, and await media from those originators 104 that choose to upload their captured media content. Thus, system 100 advantageously provides for the interaction between subscribing originators 104 and third party requesting enterprises 118 to allow for the almost-instantaneous and seamless dissemination of real-time media content from an originator's cell phone to media organizations throughout the world.

Of course, system 100 can also be applied to catastrophic or life-threatening events. Obtaining information about a missing child, hurricane, or repeated car accidents occurring at an intersection due to a faulty traffic signal have their obvious benefits. System 100 can provide originators 104 with incentive plans upon joining the system, in the form of, for example, monetary compensation, thus encouraging originators 104 to supply media content to repository 108. In addition, the public at large gains the benefit of an increase in the amount of important real-time events that might not otherwise be captured.

One feature of system 100 is a media content categorization system that allows content to be identified and categorized in order to provide maximum benefit to customers that seek quality news content in a timely manner. Customers can be identified as any third parties, whether news agencies or individuals that subscribe to news-distribution system 100 and that seek media content. Identifying content that is likely to be of high public importance is an important consideration for a news-distribution system. News items must be delivered quickly to maximize value to all subscribers of system 100. System 100 allows customers to identify incoming images of interest immediately following successful image upload of images from the originator's media capture device 102, improving upon the archaic system that historically has required many hours to locate stories of interest, send film crews to the site of the event, and transmit images back to the newsroom for subsequent editing prior to broadcasting of a news story about the event 106.

To achieve this objective, system 100 coordinates the delivery of images that have already been accurately characterized by the time they are presented to a newsroom for search. One method of characterizing images is through metadata population, wherein the subject of a given image is described either prior to upload or immediately afterwards. System 100 contemplates image metadata being created and/or edited from three different perspectives, including by originator 104, by repository 108 via manual or automatic metadata imaging, and a by a customer of system 100, as a refinement technique prior to image selection and playout. This arrangement advantageously delivers an accurate image search to the system customer as quickly as possible, with the least amount of post-upload effort invested by the customer.

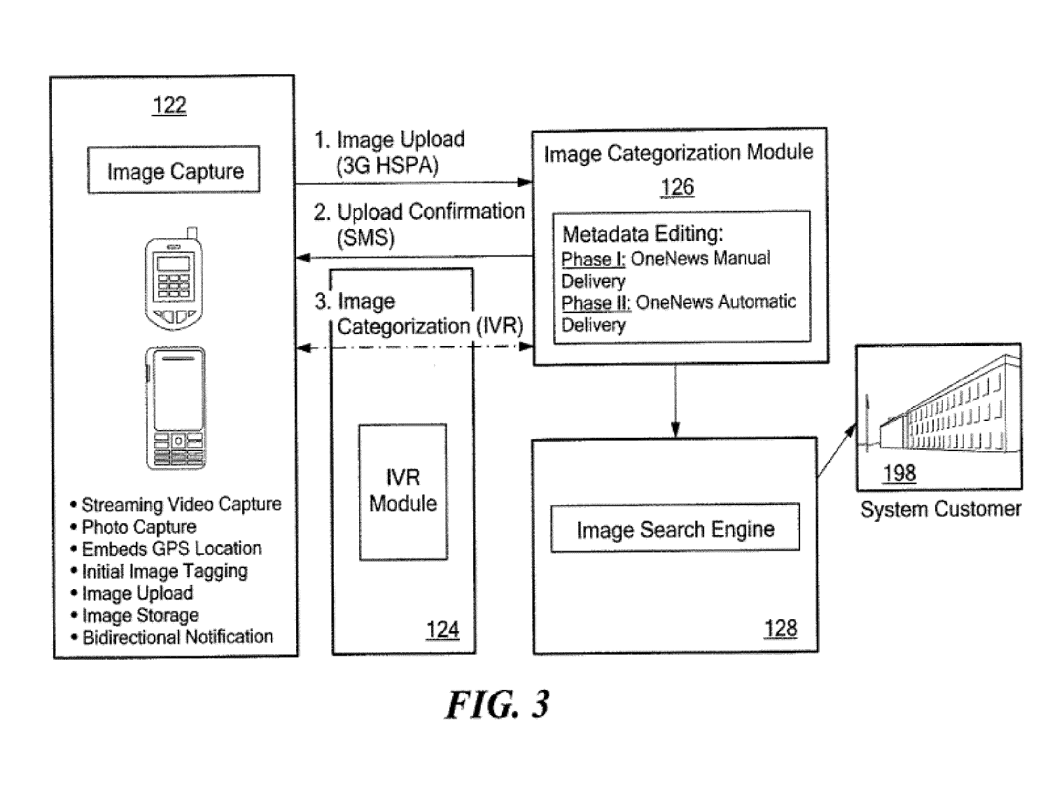

FIG. 3 illustrates an example of interactive modules used in the on-line media distribution system 100 of the current subject matter. System 100 includes Image Capture Module 122, IVR Module 124, Image Categorization Module 126, and Image Search Engine 128. Image Capture Module 122, which resides on image capture device 102 includes the hardware, software, and interface modules to allow an originator's image capture device 102 (i.e., a cellular phone), to capture image content, upload, that content to repository 108 or third parties via any standard mobile telephony protocol such as High Speed Packet Access (HSPA), receive and transmit messages to repository 108 or third parties, and store all or portions of the content on the image capture device 102.

Module 122 captures image content of an event 106, where the “image” could be a photograph of the event 106, and/or audio or video of the event 106. Image Capture Module 122 allows the originator 104 to perform initial image tagging using a news exchange standard such as for example, EventsML-G2-compliant metadata descriptors. Image capture device 102 may also be enabled to store the captured image in the event that cellular infrastructure is unable to transmit the image to the repository 108 streaming due to, for example poor cellular signal or crimped bandwidth due to cellular tower overload. This allows originator 104 to store the image content for delivery at a later time.

Image capture devices 102 that are equipped with GPS transmitters can geocode captured images enabling image authentication and real time originator location information to be transmitted to repository 108. Time stamp, date stamp and GPS or cell-site triangulation information can be received by repository 108 or third party enterprise organizations 118 along with the images and correlated with the images to provide time, date and location of event 106. Confirmation that the image was received by repository 108 can be sent back to the originator's image capture device 102 via any standard communication protocol such as, for example, the Short Message Service (SMS) protocol. Image Capture Module 122 may also include software to allow for the receipt of third party text messages, i.e., “pings”, from enterprises 118 wishing to inform certain originators 104 about real-time activities occurring in their geographic locations that may require additional coverage in the field, as well as for the transmission of messages to the sending party.

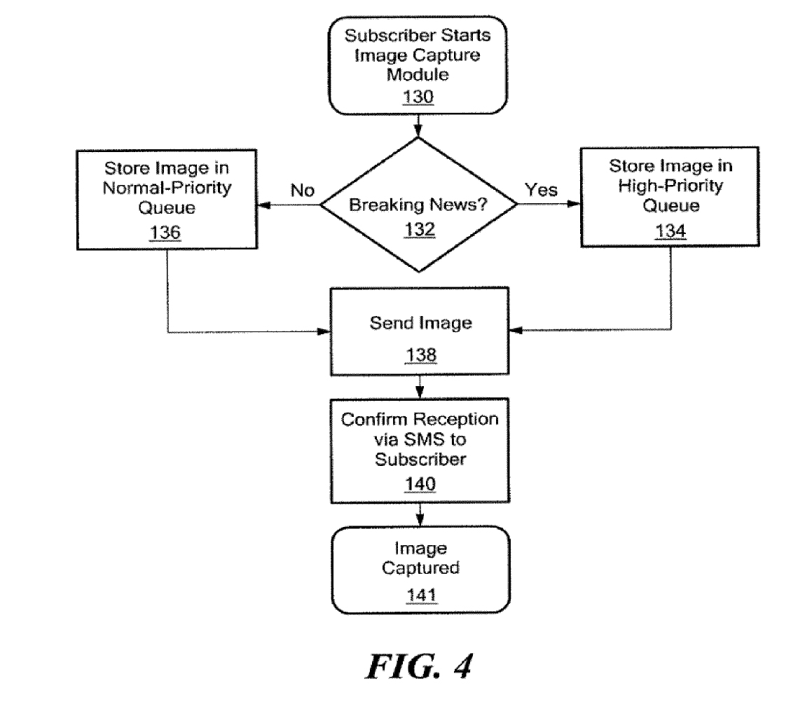

FIG. 4 is a flowchart illustrating an exemplary communication between an originator or subscriber 104 and repository 108 when images are captured on the originator's image capture device 102 and are to be transmitted to repository 108. At 130, an originator 104 that has subscribed to the on-line media distribution system 100 of the current subject matter captures an image of au event 106 utilizing Image Capture Module 122 residing in the originator's media capture device 102. Depending upon the availability of cellular service in the area, the image can be temporarily stored on image capture device 102 and then sent to repository 108, or, if network 114 is operating, immediately upload the captured media to repository 108.

At 132, a dialogue box presented to the originator 104 on his or her image capture device 102 prior to image transmission, requests the originator 104 to identify whether the image should be categorized as “Breaking News”. The definition of what constitutes “Breaking News” is arbitrary and predefined and communicated to each originator 104 upon subscribing to system 100. If the image qualifies as “Breaking News”, a copy of the image is moved, at 134, to a high-priority processing queue in repository 108 after it has been transmitted to the repository 108. If it does not qualify as “Breaking News”, then, at 136, a copy of the image is stored in a normal-priority queue in repository 108 once it has been transmitted there. At 138, the image is transmitted from device 102 to repository 108.

It is within the scope of the current subject matter to first transmit the image from device 102 to repository 108 at 138, and once the image arrives in repository 108, to then determine if the image qualifies as “Breaking News” or not. The determination of whether or not media content qualifies as “Breaking News” or any other threshold level of news, can be based on information relayed to repository 108 from originator 104 along with the uploaded media content, and/or input from other originators 104 (for example, many uploaded images or content from other originators 104 in the same geographical location might reinforce the importance of the event 106). Once the image is transmitted to repository at 138, an Upload Confirmation may be sent, at 140, from repository 108 to the subscriber via, for example, an SMS delivery, to confirm that the image that was captured by device 102 has been received by repository 108, at 141.

Referring again to FIG. 3, IVR (Interactive Voice Response) Module 124 and Image Categorization Module 126, each residing within repository 108, form an interactive mechanism to allow for the categorization of media content. The captured image will be initially categorized by the subscriber 104 using one of a number of techniques according to the principles of the current subject matter. One image categorization technique offered to subscriber 104 is an IVR Dialogue Module, while another is a Web-Based Entry. In some implementations, the IVR Dialogue technique is offered as the default choice unless otherwise identified by subscriber 104. As part of the initial program start, image Capture Module 122 will interrogate subscriber 104 as to image categorization preference.

Both the Web-Based Entry and IVR Dialogue approaches involve the subscriber 104 completing two distinct activities. First, the subscriber 104 will be asked to navigate through a series of questions designed to quickly place the image into one of a plurality of subjects. These subjects could be randomly generated or be subjects designated by the International Press Telecommunications Council Subject Reference System (IPTC SRS). Next, subscriber 104 will be asked to describe event 106. The verbal event transcription will be stored and filtered through repository's Audio-to-Text translation module, allowing the text description to convert into searchable metadata. It should be noted that the quality of the resulting metadata will vary depending on the accent of subscriber 104, connection clarity, coherence of expression and other factors. Finally, Image Capture Module 122 can transmit geocoded images enabling incoming submissions to be geographically located. Between the initial SRS categorization performed by the subscriber 104, the verbal event description, and the GPS location transmitted with the image, a usable categorization can be delivered immediately following image transmission, thus allowing a system customer 198 to be search for and/or be presented with captured content of interest.

IVR Module 124 operates as follows: once an image has been received, repository 108 will index the image (i.e., place it in the appropriate priority queue) and instruct an IVR front-end interface module to contact the originator 104 and walk the originator 104 through a dialogue that assists in categorizing the image. The repository 108 will subsequently expand the image metadata and re-index the image, enabling newsroom search. For example, originator 104 may be presented with an IVR menu that corresponds to the designated IPTC SRS Top-Level Subject categorization and may appear as shown in the menu below. The IVR menu can be constructed to present the most newsworthy categories first on the menu in order to enable quick initial placement by the subscriber. As example is provided in Table 1 below.

TABLE 1

| | English | Reference |
|---|---|---|
| Top-Level Subject | Abbreviation | Number |
| Arts, Culture and Entertainment | ACE | 010000000 |
| Crime, Law and Justice | CLJ | 020000000 |
| Disasters and Accidents | DIS | 030000000 |
| Economy, Business, and Finance | FIN | 040000000 |
| Education | EDU | 050000000 |
| Environmental Issues | ENV | 060000000 |
| Health | HTH | 070000000 |
| Human Interest | HUM | 080000000 |
| Labor | LAB | 090000000 |
| Lifestyle and Leisure | LIF | 100000000 |
| Politics | POL | 110000000 |
| Religion and Belief | REL | 120000000 |
| Science and Technology | SCI | 130000000 |
| Social Issues | SOI | 140000000 |
| Sport | SPO | 150000000 |
| Unrest, Conflicts and War | WAR | 160000000 |
| Weather | WEA | 170000000 |

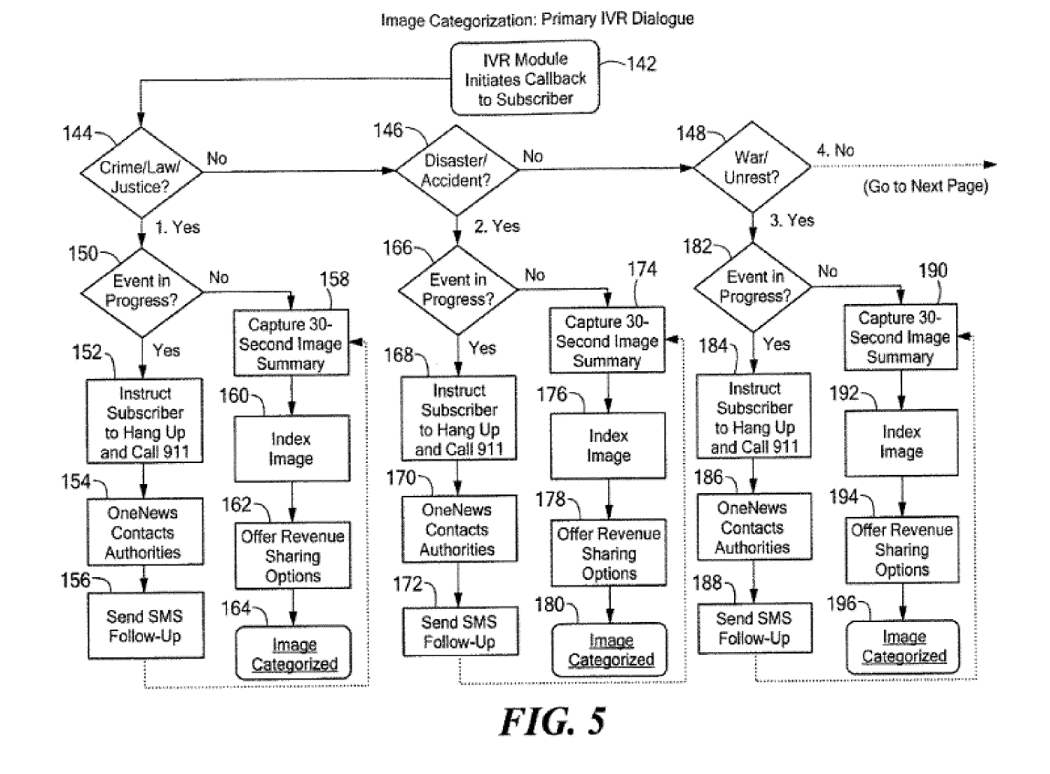

An exemplary IVR dialogue is shown in FIG. 5 and discussed below. Subscriber 104 contacts repository 108 and indicates that they have a captured image of an event. At 142, IVR Module 124 contacts subscriber 104. Subscriber 104 is asked to categorize the image into one of the Top-Level. Subjects shown in a menu presented to the subscriber 104. For example, at 144-148, subscriber 104 is asked if the event is related to a crime or legal matter, a disaster or accident, or a war or matter related to political unrest. Thus, the subscriber 104 is selectively given the opportunity to identify events that may impact public safety and if so identified, the image is flagged at a highest possible priority, and law-enforcement and/or public-safety officials may be notified. For example, if a crime is in the process of being committed, then, at 150-156, subscriber 104 is instructed to hang up and contact 911, while repository 108 contacts the appropriate authorities and a follow up message is sent to subscriber 104. If the criminal event has already occurred then, at 158-164, the subscriber 104 captures an image of event 106 and it is indexed and categorized accordingly. Similar scenarios can occur if the event is an accident, at 166-180, related to war or political unrest, at 182-196, or any other categorized subject.

In some implementations, subscriber 104 is given a fixed amount of time, for example, thirty seconds, to describe event 106. Following the dialogue, this description is stored as audio metadata and can subsequently be filtered through a speech-to-text mechanism having an output that can be also stored as (searchable) text-based metadata. Subscriber 104 can be offered compensation of delivery of the image according to one of a number of revenue sharing plans. Images can be categorized either prior to or after upload from device 102 to repository 108 via network 114 via the use of image metadata. The subscriber 104 may create or edit the metadata, or this could be done by repository 108 via a Metadata Editing Module within Image Categorization Module 126, which can perform editing either manually or via an automated process. Consumer 116 or buyer 118 could also edit the metadata as a refinement technique prior to image selection and playout. Regardless of where the image metadata editing occurs, consumers 116 and buyers 118 will be provided with the ability to accurately search for images with a minimal investment of effort.

In some implementations of the invention, an Image Quality Management System (“IQMS”) is used as a reputation-based rating system to present search results to customers of system 100. With this approach, images submitted by subscribers 104 are rated by system customers as well as other users of system 100 such as staff members. Over time this enables subscribers 104 who have built a reputation for high-quality images to “rise to the top” of any given search, enabling the system customer base to build a “known-to-be-good” base of reliable originators 104, avoiding situations where system customers are spending inordinate amounts of time trying to determine whether a given event submission should be trusted. Thus, query results displayed at the repository 108 console will default to highlight submissions from subscribers 104 with “known-to-be-good” backgrounds.

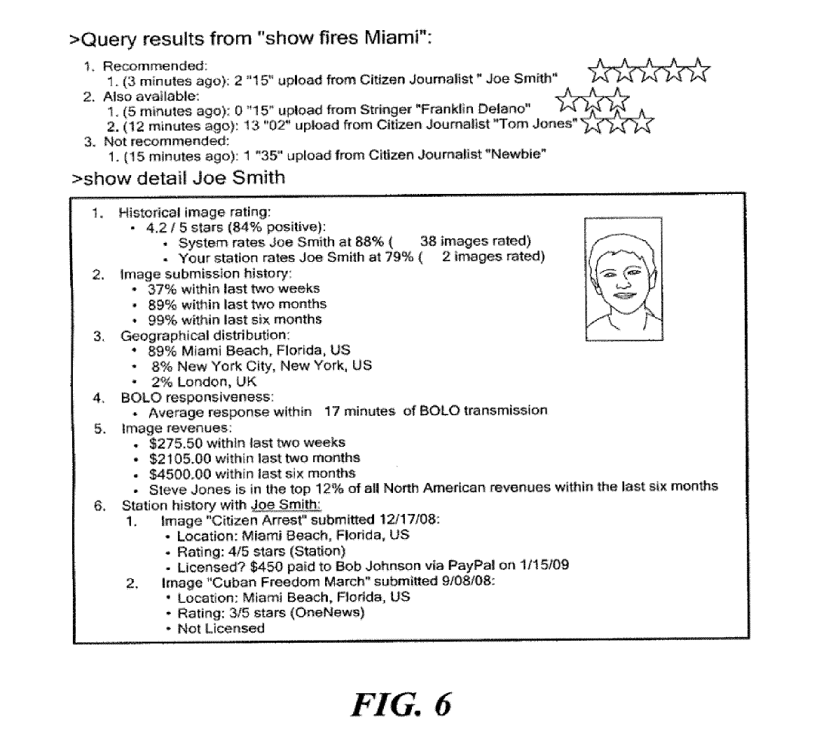

FIG. 6 is an exemplary screen that may be presented to a consumer 116 or buyer 118 of system 100 that would like to find a subscriber 104 knowledgeable about fires occurring in Miami. Based upon this search entry, system 100 presents a screen with a highly recommended subscriber 104, i.e., Joe Smith (with a five star confidence rating), with other subscribers 104, i.e., Franklin Delano, and Tom Jones, listed with a lower confidence rating (three stars). The screen shows how long ago each subscriber 104 uploaded their image and how large the image file is or how long the audio file is. Exemplary criteria used by system 100 to rate each subscriber 104 can been seen in the to portion of the screen of FIG. 6, which shows detailed information for subscriber Joe Smith.

Referring to FIG. 6, many different criteria for Joe Smith can be viewed. For instance, Smith is given an average historical image rating, i.e., 4.2 out of 5 stars, a system rating based on the timing and quality of previously submitted images, and another rating submitted by the customer 116 or enterprise 118 seeking the information, based upon their past experiences with Joe Smith. Other rating that can be shown are an Image submission history, i.e., the percentage of times Smith submitted an image in response to a third party request, a Geographical distribution summary which shows the geographic location of the events Smith has captured and uploaded, a BOLO responsiveness rating showing how quickly, on the average, Smith responded to a third-party (BOLO) request, the amount of revenue realized by Smith for submitted images, and a summary of Smith's previously submitted images. The screen presented in FIG. 6 is exemplary only, and it is within the scope of system 100 to provide a summary screen with a variety of user and system information and rating criteria.

System 100 allows for the monitoring and control of the quality of content received from the many originators 104 that subscribe to the news system 100. Authenticity of the media content and originator 104 can be assured using one or more of a variety of security techniques including having the originator 104 signing an affidavit attesting to content authenticity, and/or making representations and warranties that the images are true, real and un-doctored, transmitting to repository 108 an Electronic Serial Number (ESN) or an Electronic Identification Number (EIN) with the captured image at the time of upload, or recording the originator's voice to obtain a digital voice stamp for further security. Recorded data can include time, date, location, event description, observations, contact information and a recorded verbal affidavit of truthful disclosure

Repository 108, upon receipt of many uploaded images, can, with the use of its processor and related software applications, depict news information in a graphic presentation thus allowing for the rapid analysis of news “clusters” based on proprietary algorithms incorporating a variety of parameters. In addition to clustering relevant data, another part of the graphic depiction can provide velocity, acceleration and vector analysis of the inbound information. For example, in the event of either a forest fire or civil unrest, the rate of uploaded information and the vector depicted on a map may help depict trends in real time and assist law enforcement and/or other agencies in assessing the threat and addressing the issue. Thus, the current subject matter can advantageously be used to assist organizations outside the news agency arena.

As discussed above, repository 108 is able to record the time stamp, date stamp, and GPS signal of the uploaded data transmission. As an example of the applicability of the current subject matter to other agencies, repository 108 can correlate the time-stamped, data-stamped and GPS information with a global weather database and store that information for future reference. The use of GPS information can also assure the authenticity of the originator's content. For example, consider a situation where originator 104 claims to have witnessed a bank robbery at “the corner of First and Main” when in fact they stated the image at a different location in order to fool news organizations and collect a fee for the sale of the image of the staged event. System 100 would be able, through received time-stamped meta-tags and GPS information, to determine if originator 104 was indeed at the corner of First and Main at the time the image was uploaded to repository 108.

Another example of the far-reaching applicability of the current subject matter is the use of system 100 in the legal arena. The analytical tools provided by system 100 provides for the rapid assessment and correlation of data that might otherwise go unnoticed. For example, attorneys might use the service to assist in legal cases were car accidents occur repeatedly at an intersection. While each individual event, taken alone, may constitute “only” a car accident, the aggregate of information regarding multiple car accidents at the same intersection could be of great interest. System 100 would be able to provide video, still photographs and audio/text information about each event and could be used in court as evidentiary information. This information further correlated with time stamp, date stamp and weather information may show, for example, that when it rains and the temperature falls below, for example, 55 degrees the streetlight at a particular intersection fails to operate, therefore resulting in one or more serious injuries or fatalities at the intersection of interest.

System 100 could provide law enforcement agencies with a comprehensive set of data related to, for example, suspicious persons, events, missing children, etc. Thus, law enforcement agencies will have, at their service, potentially hundreds of millions of “officers” worldwide, providing a powerful asset to all law enforcement agencies that take advantage of system 100. Repository 108 can transmit the video images live directly to law enforcement agencies, therefore enhancing to the current scenario in which a verbal description of a perpetrator (e.g., medium height, olive skin, red shirt) is replaced with an actual image of the perpetrator holding up the bank, or involved in a terrorist activity. Therefore, In some implementations, system 100 allows for images of a current event to be transmitted from a user's mobile phone in real time to a central repository 108, and from there directly to a law enforcement dispatch/operator who in turn transmits the image to the computer screen of the responding officer's patrol car.

As discussed above, originator 104 can choose to upload media content for return compensation. If originator 104 decides he or she wants compensation for the uploaded electronic media, then the central repository 108 forwards the electronic media to the revenue sharing device 112. In some implementations, originator 104 also sends a compensation parameter, or value indicator along with the electronic media. The value indicator may be a dollar amount, percentage, or a numerical factor. Furthermore, the value indicator may represent the originator's perceived value of the electronic media, a minimum amount the originator 104 is willing to accept as compensation for the electronic media, or a portion of the final sale price.

When the revenue sharing device 112 receives the electronic media, it stores it into computer memory such that at least a portion is accessible to potential buyers 118. If a buyer 118 purchases the media content, a number of payment options are available. These payment options include, but are not limited to, transferring payment to the bank account belonging to the operator of the central repository 108, paying by credit card, or having the operator of the central repository 108 mail an invoice to the buyer 118. Notably, it is advantageous to the buyer 118 to have a centralized supplier (i.e. the operator of the central repository 108) for the purpose of making efficient and convenient payments.

Content stored in revenue sharing database 112 can be made available to news agencies 118 via a number of different ways. In some implementations, a fixed-price system will post content at a specific price, and third parties may purchase or license the offered content. In another embodiment, repository 108 establishes a bidding system whereby agencies 118 enter their bids for specific content. For example, when a newsworthy event 106 occurs (fire, tornado, bank robbery, etc. . . . ), originator 104 captures the event 106 with his/her mobile device 102. Originator 104, having previously subscribed to system 100, can be equipped with an image capture device 102 that is specifically enabled to allow originator 104 to seamlessly capture and upload media content to repository 108, via, In some implementations, a “one-touch” button that allows the originator 104 to upload content directly to repository 108 directly from their media capture device 102. Originator 104 may also be given the option to transfer their media to their personal computer and to transmit the image directly from their computer to repository 108 via the Internet. Thus, with the press of a button, the captured image can be uploaded to content repository 108.

News organizations 118 can bid for content made available on the Internet by repository 108. For example, system 100 can post on their website images about a specific news event. News Organizations 118 submit bids for the content and a winning bidder is identified. When an agreed-upon-price by the parties is reached, monies can be transferred from the News Organization 118 to repository 108 (and by repository 108 to originator 104). The media content may then be distributed by organization 118 to certain third parties via specific media channels in an agreed-upon territory for an agreed-upon period of time.

The current subject matter allows originator 104 to be compensated for the capture and submission of an event 106. A computer processor in the revenue sharing device 112 computes the compensation an originator 104 is to receive from the sale of his/her electronic media. The current subject matter incorporates a compensation pricing model that can incorporate geographic territory rights, terms of exclusivity, form of media, time constraints, and others factors. When each originator 104 signs up to the news-distribution system 100 of the current subject matter, they can select a compensation option. Originator 104 can be given the option to pre-purchase up to 100% of the image revenues. A default model can be, for example, that originator 104 will receive 50% of the realized value, or revenue generated from the sale of an uploaded image without paying any fee to repository 108. Originator 104 can be given the option to purchase additional 10% increments at $1 each. For example, a $5 investment will allow subscriber 104 to purchase 100% of the revenue from his or her uploaded image. Thus, each subscriber 104 can receive compensation for their captured images that are uploaded to repository 108 by submitting to repository 108 at least one desired compensation parameter, whether it be a percentage of the ultimate purchase or license fee of the image, a compensation fee dependent upon the newsworthiness of the image, a fee dependent upon the subscriber's perceived value of the image or some other factor.

Other compensation schemes would allow originator 104 to receive a higher percentage for content that is deemed more newsworthy. Thus, originator 104 might be willing to sign up for a compensation plan that requires a higher initial payment for “Breaking News” content, but that would result in a higher payment percentage in return for the uploaded media. Other schemes could include factors such as how quickly originator 104 responds to a BOLO request (the faster the more money received) and the geographic location of originator 104 (sending media from a remote location, far from the originator's home might result in higher compensation).

In other compensation schemes, the computer processor utilizes an algorithm that incorporates a number of parameters. These parameters include but are not limited to perceived value of content (PVOC), actualized value of content (AVOC), distributable revenue (DR), length of exclusivity (LOE), territory rights (TR), media usage (MU), viewer rating value (VRV), uniqueness of content (UOC), percentage of participation (POP), reporter revenue (RR), and other (O).

An exemplary compensation algorithm is: RR=(PVOC*AVOC*DR*POP*(OE+TR+MU))/U0C. in this algorithm, the PVOC corresponds to the value indicator submitted by the originator 104. The other parameters of the algorithm are generally predetermined or assigned by authorized, individuals on a case-by-case basis, however, they may also be provided by originator 104. Additionally, the algorithm and the values associated with the parameters may or may not be available to originators 104 and buyers 118. It may be advantageous to keep the algorithm and its parameters unpublished, so as to keep originators 104 from circumventing the revenue sharing device 112 or from disputing values of the parameters.

Once the appropriate compensation is computed, the revenue sharing device 112 initiates a payment to the originator 104 of the purchased content. This payment may be made in a number of ways including, but not limited to, sending the originator a check, depositing the payment into a registered account, (such as, for example, crediting the cell phone bill), or transferring the payment to the originator's bank account. Furthermore, the manner in which the originator 104 receives payment may be determined by the originator 104 prior to or at the time of uploading the electronic media to the central repository 108.

In some implementations, the current subject can be configured to offer to the news and publishing industry a way to lower costs, increase breadth of coverage, engage customer base, reduce the time of acquiring content, and/or address digital rights management issues all through an integrated solution that can solve a challenge of how to control and manage citizen reporting. In some implementations, some of the advantages of the current subject matter can include significant cost-savings, faster content publishing through use of faster communication networks (e.g., 3G and 4G wireless communication networks, or any other networks), greater breadth of coverage through use of localized reporting (e.g., on-the-spot photographing, video-taping/recording, audio-taping/recording, etc.), more exact and timely reporting of the events that may be happening in real time, distribution and dissemination of brands of organizations that are seeking acquisition and distribution of content, as well as, many other advantages.

In some implementations, the current subject can be configured to provide a robust, fully automated enterprise level solution, such as a content acquisition valuation and distribution exchange system that can streamline aggregation of content captured using various communication devices (e.g., mobile telephones, iPads, iPods, smartphones, Palm devices, personal computers, laptop computers, video and/or audio recording devices, and/or any other devices or a combination of devices) and broker distribution of content to various organizations (e.g., news organizations, media organizations, government organizations, private entities, individuals, emergency services, hospitals, police, firefighting services, environmental services, etc.). The current subject can be further configured to allow various organizations to efficiently manage and communicate with a global pool of field reporters to capture and ingest time-critical user generated content (e.g., news content, situational content, status, predictions of future events, etc.). The current subject matter can be configured to provide the above functionalities and abilities through integration of devices having or being equipped with a position-recognition technology (e.g., global positioning systems, satellite systems, etc.) with an enterprise backend platform, as discussed above in connection with FIGS. 1-6. In some implementations, use of such devices can allow the current subject matter to provide a geographic map view around the globe of available reporters, thereby allowing organizations to pick and choose the number and skill level of any number of field reporters that may be registered with the system. In some implementations, the current subject matter can be configured to obtain content within a short time frame (e.g., seconds, minutes, etc.) or substantially simultaneously.

In some implementations, an entity desiring acquisition of particular information may create a request or an assignment and present such assignment to a network of registered information originators or reporters. The entity can be a media content buyer, a media outlet, a government organization, a news organization, an emergency services organization, or any other entity/entities (such as a buyer entity 118, as shown in FIG. 1). For example, an entity may be a local news organization that may be looking obtain videos and/or photos of celebrities attending a charity event. Thus, an assignment may be distributed to the entire network of registered content providers or originators (such content originator 104) and/or it can be provided to a selected content provider and/or a group of providers. The assignment can be based on a geographical location of the event and/or content provider(s), time of day, time of the event about which information is to be acquired, skill of the content provider, device(s) that will be used by the content provider, personal characteristics of the content provider, ability to actually obtain desired content, as well as any other factors. Alternatively, the entity can be a media buyer or a broker for another entity trying to purchase content.

In some implementations, content can be provided to, obtained, requested, purchased, etc. by a registered media buyer (such as a buyer 118 shown in FIG. 1). In alternate implementations, a non-registered media buyer can also obtain content (or a limited version of the content, e.g., older content, portions of the content). Content can also be provided to the non-registered media buyer on a free-trial basis so that the media buyer can assess whether or not such acquisition of content is desired. In some implementations, certain buyers can be granted free access to view and/or request full content (e.g., certain government organizations, emergency services, etc.). The media buyer can include at least one of the following: news organizations, media organizations, government organizations, private entities, individuals, emergency services, hospitals, police, firefighting services, environmental services, etc.

The media buyer can be configured to control a vast pool of content providers, reporters, journalists, etc. (hereinafter, “reporters”) that are capable of providing various content, which can include a sought-after content (e.g., a photograph of a newly-born cub of a polar bear at a local zoo), an on-going content (e.g., relief efforts in connection with an aftermath of a devastating earthquake), on-the-spot content (e.g., a video of an occurring automobile accident), and/or any other content. In some implementations, the current subject matter's system can allow the media buyer to perform filtering and searching of content submitted by reporters using channels (as will be discussed below) that can sort out and discard low interest content and select high interest content for review by the media buyer.

In some implementations, the media buyer can also create assignments for reporters to obtain content, whereby a reporter can be directed to a particular event, location, etc. to obtain such content. A particular reporter can be requested to complete a particular assignment based on reporter's location, knowledge, skills, equipment, characteristics, etc. Selection of qualified reporters to fulfill assignments can be advantageous to the media buyer seeking to obtain content in a fastest possible time while lowering costs to obtain such content. The media buyer can also use channels to filter, search, etc. content based on multi-level search parameters that can provide, for example, daily to instant reports of recently submitted content that matches the media buyer's criteria.

In some implementations, a media buyer can be configured to create a media buyer account for requesting, obtaining, searching, filtering, etc. content. The media buyer account can be configured to allow the media buyer to use predefined buying preferences that can provide optimization of decision-making for purchasing of ad-hoc media, an ability to create separate user accounts, which can control and/or limit permissions, management of assignments and content that can be requested and/or received, and other options. The media buyer account can include various information that can include standard business information, such as main contact, mailing and billing addresses, preferred payment method, etc. This information can be used for providing communications between content requesting organization (e.g., news organization), a media buyer (which can be a third party if it is not the same as the content requesting organization), and the current subject matter's system. The account can also display the content requester's logo information for brand distribution purposes. The logo can also be provided to reporters that are obtaining content, so that the reporters know for which organization, the content is being gathered.

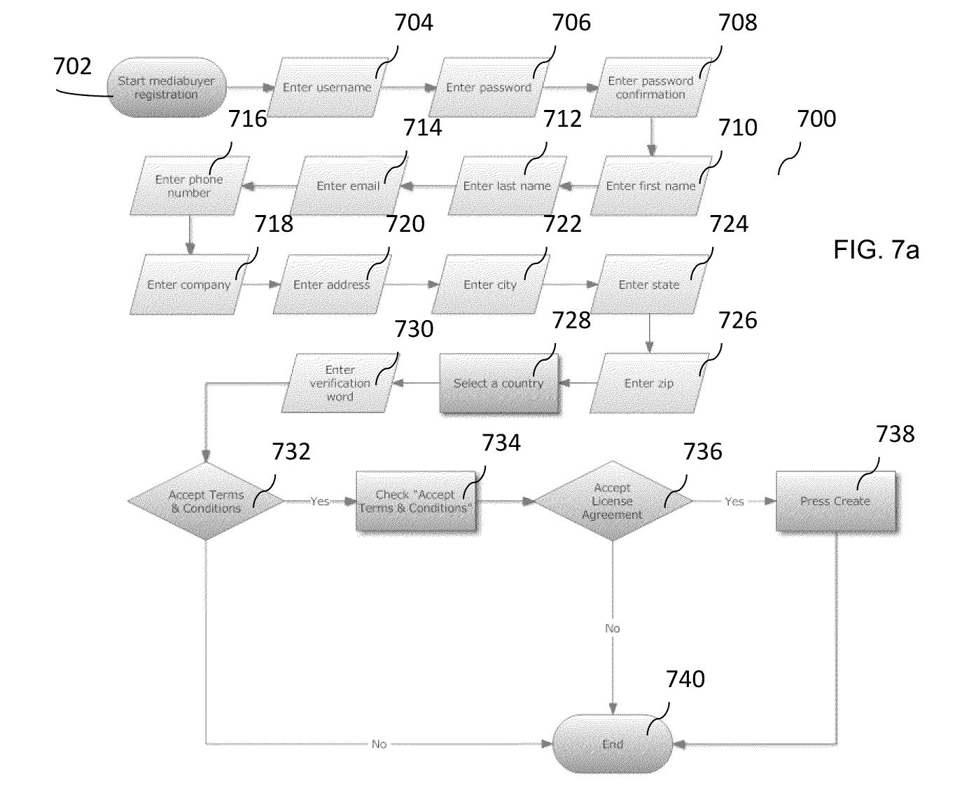

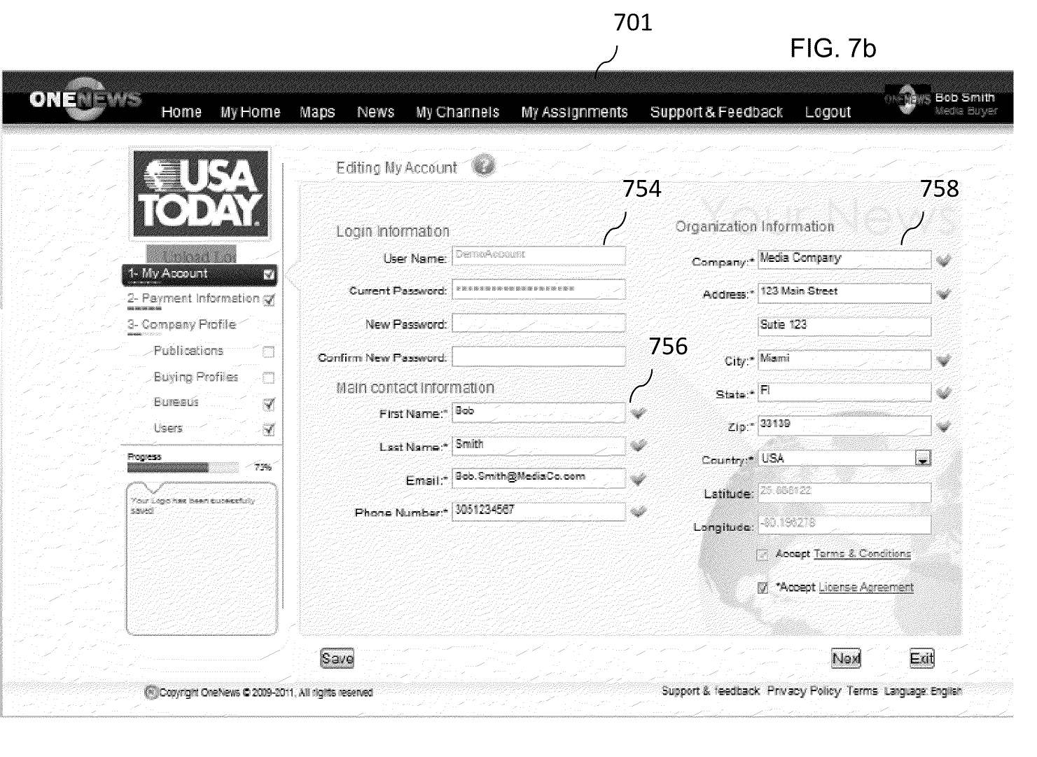

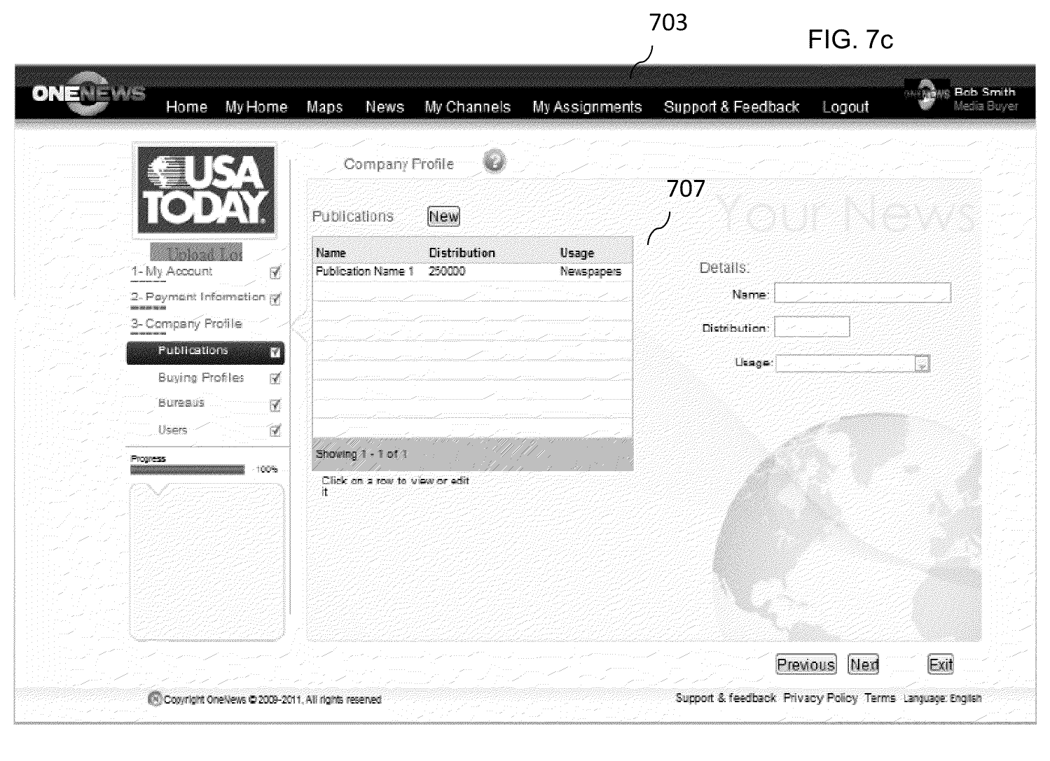

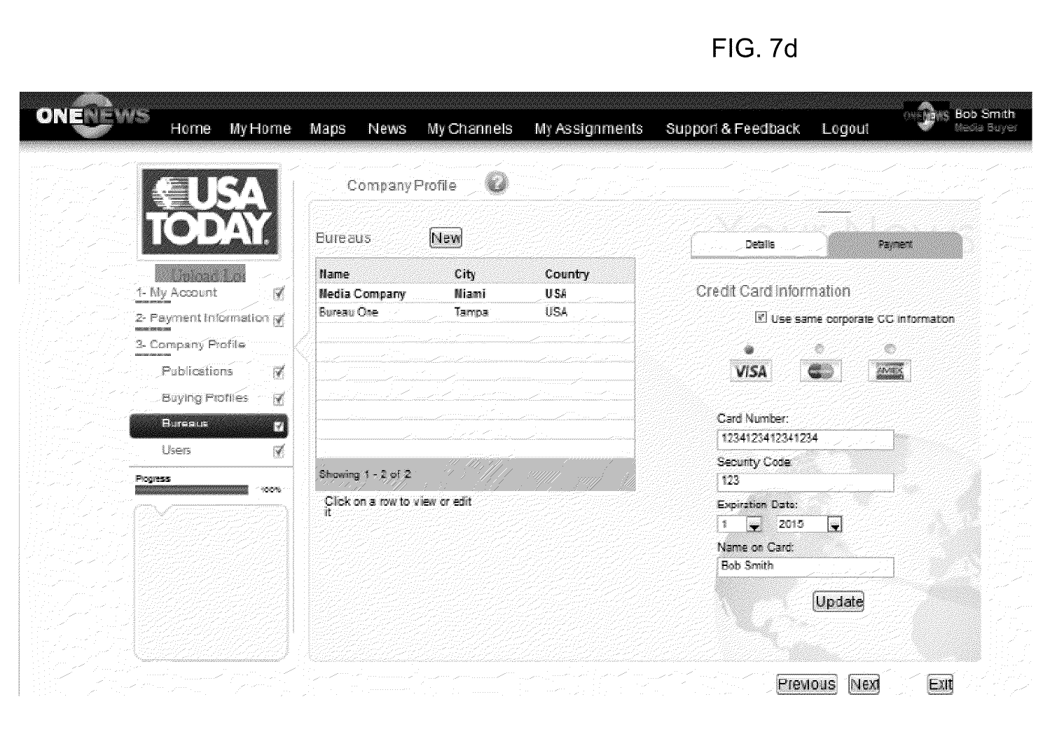

FIG. 7a illustrates an exemplary method 700 for registering a media buyer, according to some implementations of the current subject matter. At 702, a registration of a media buyer can be initiated. The media buyer can enter media buyer login information, including a username, a password, and confirm password, at 704-708. Once the login information is entered, the media buyer can enter personal information about the media buyer and contact information for the media buyer, including first and last names of the contact information, email address, telephone number, name of the media buyer, address, city, state, zip code, country etc., at 710-728. The media buyer can also enter a verification word to protect the media buyer account, at 730. Once the terms and conditions of using the system (such as a system 100 shown in FIG. 1) are accepted by the media buyer, at 732-736, the media buyer can complete creation of the media buyer account, at 738 and end the process at 740.

FIG. 7b illustrates an exemplary user interface 701 illustrating registration account of the media buyer, according to some implementations of the current subject matter. The user interface 701 can be viewed by the media buyer's registrant on a personal computer, a laptop, iPad, iPod, iPhone, smartphone, Palm device, personal computing tablet, or any other device. The user interface 701 indicates content requester's logo 752 (e.g. “USA Today”), login information of the media buyer 754, contact information of the media buyer 756 (e.g., “Bob Smith”), and media buyer organization information 758 (e.g., “Media Company”). Other variations of the user interface 701 are possible. In some implementations, the media buyer can be the same as the content requester or can be a third party that the content requester may hire to seek out and process content on its behalf. When content is assigned to a particular reporter, the reporter can also be provided with information about the content requester, including content requester's logo. This can allow for distribution of the requester's brand and hence, can create brand awareness and loyalty among reporters with respect to a particular requester.

In some implementations, each content requester can have predefined content publishing properties and can setup predefined data records for each of these media properties so as to minimize any future repeated data entry, which can be useful in calculating licensing fees associated with management, use and distribution of content, as discussed below. Some of these properties can include at least one of the following: name, usage information, type of content, territory, reader information, Internet information, etc. The name can include a publication entity that can provide content. Usage information can include information about requests in standard media markets, e.g., broadcast, web/mobile, print, etc., a type of content, which can be based on the usage and can specify the usage end market. In the broadcast usage example, these can include at least one of the following: Internet Protocol television (“IPTV”), local and cable/satellite, etc. In the web/mobile usage example, these can include at least one of the following: World Wide Web, mobile, etc. In the printing, these can include at least one of the following: a newspaper, magazine, etc. Any other usages are possible and the current subject matter is not limited to the examples listed above. The territory can include at least one of the following: regional/local, national, worldwide, pre-defined territory, etc., and/or any other territories, and/or combination thereof. The reader information can include information concerning publication circulation for print, average unique page views per month for digital publications, etc. The Internet information can include information about universal resource locators (“URLs”), mobile application name, etc. An exemplary user interface 703 that contains information about publications 707 is illustrated in FIG. 7c.

To simplify and speed up the process of calculating complex rights managed media pricing, the content requester can predefine a set of buying preferences based on its standard purchasing habits and its current publishing properties. When a media item is found and determined to be of value for purchase, the pre-calculated pricing for that media for any of the pre-defined buying preferences can be displayed for easy and quick purchase decision making by the buyer. The content requester can include identification of publications from which content is desired as well as a term during which purchasing of content is desired.

In some implementations, a content requester can select a bureau (such as a registered media company 758 shown in FIG. 7b) that can manage its content acquisition, assignment distribution, financial tracking, budget controls, etc. The bureau can be the same as the content requester or a separate third party. An exemplary listing of bureaus for a content requester is illustrated in FIG. 7d.

Further, the content requester can also set up a plurality of user accounts to manage perform various functions for it having various permissions, e.g., an administrator that can create, delete or disable other user accounts, a purchasing authority that can be disabled so that user can only view content and has read-only functionality across the rest of the platform, and cannot initiate an financial transactions, assignment creation that can enable or disable an ability to create assignments and direct field reporters to events, and set assignment media purchase price amounts.

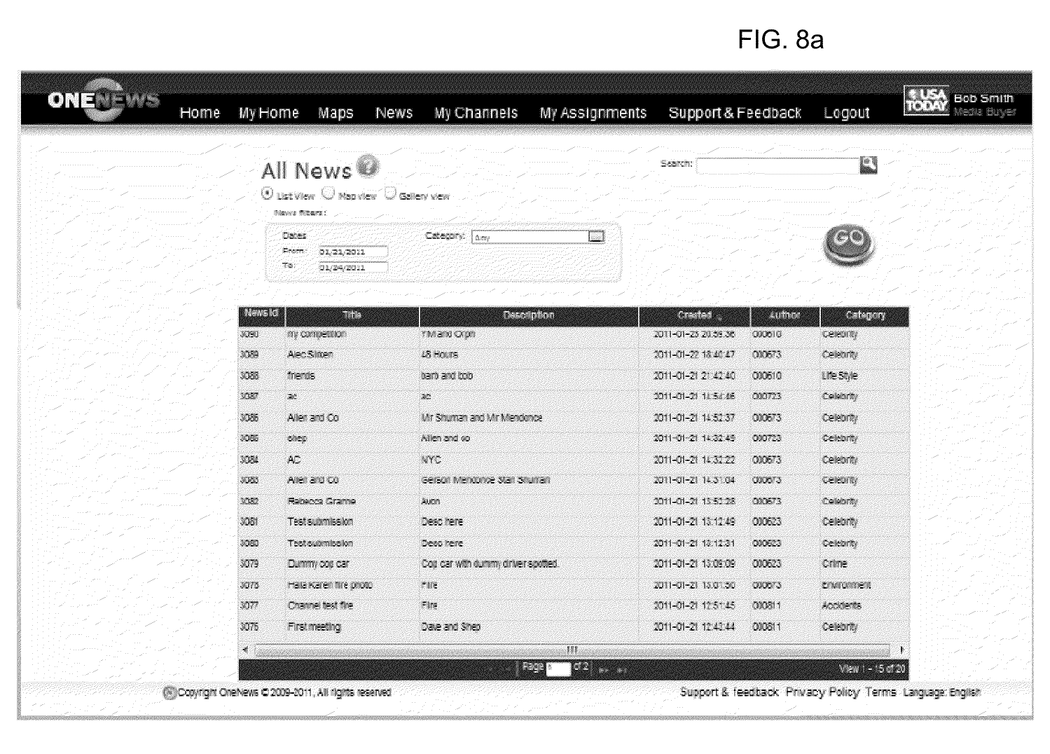

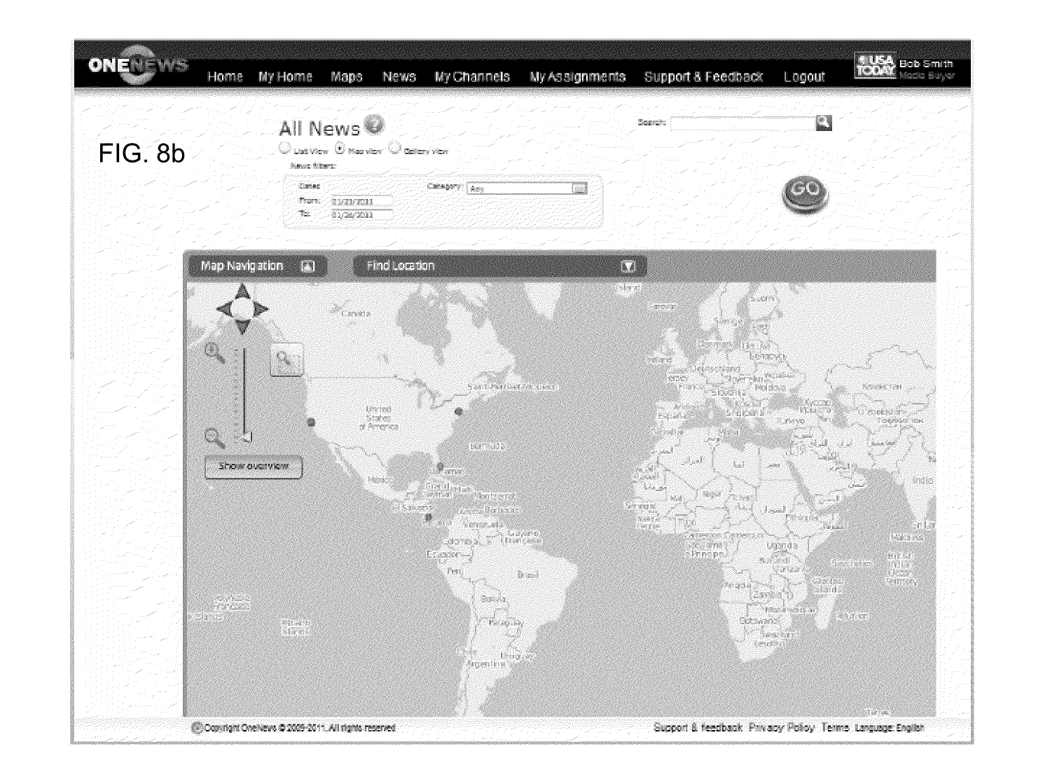

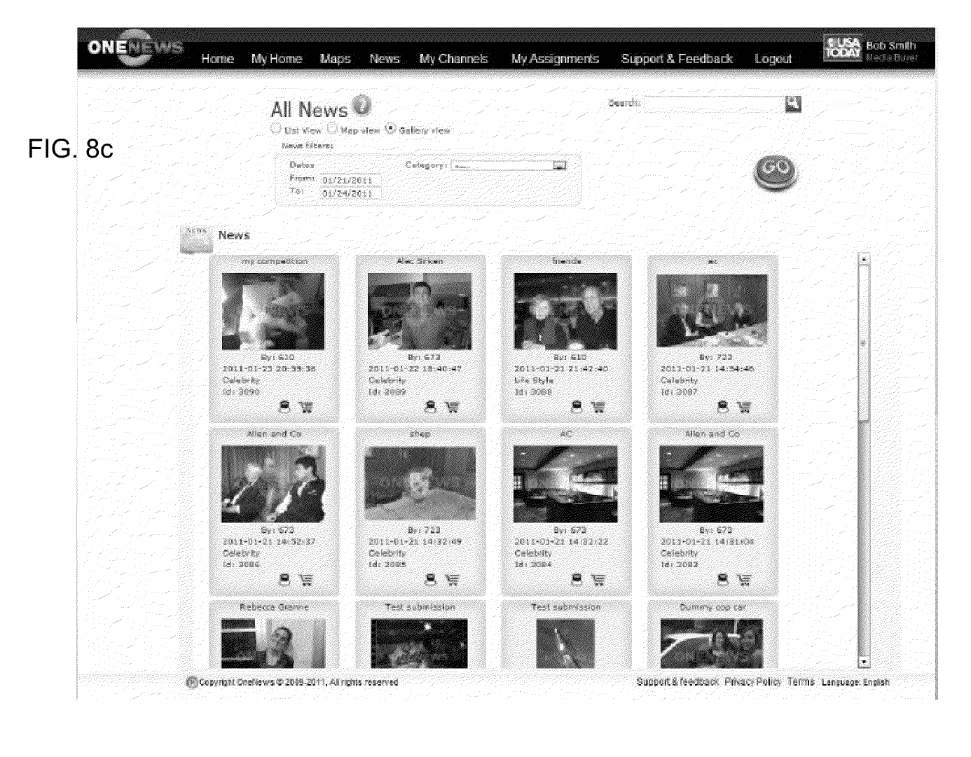

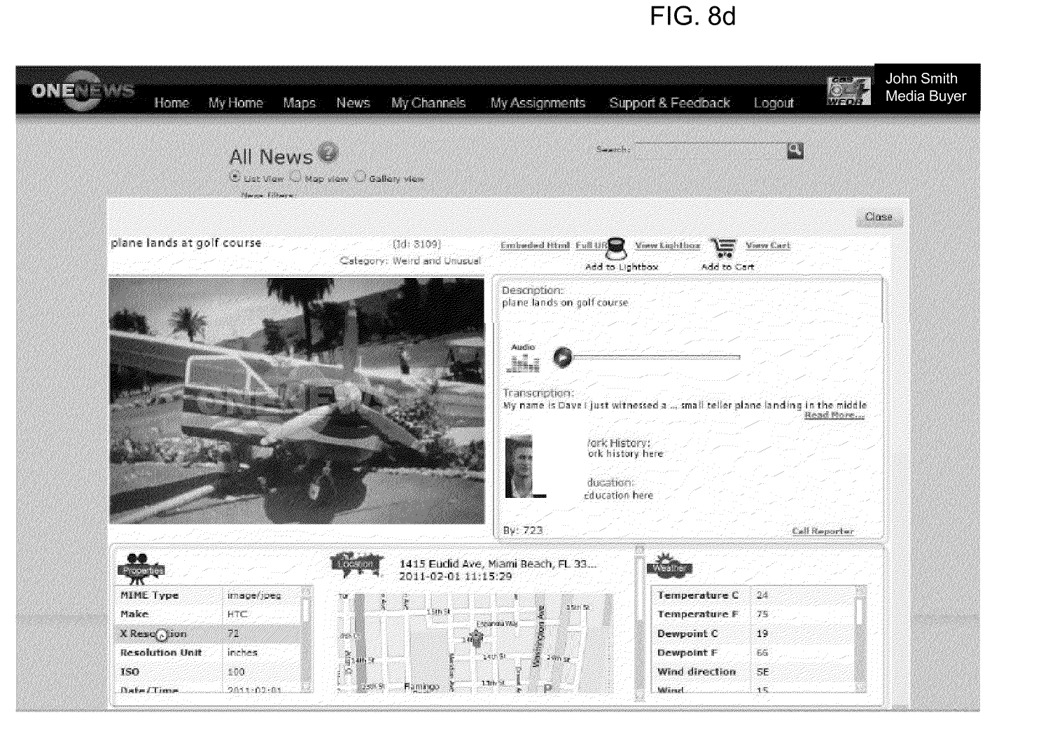

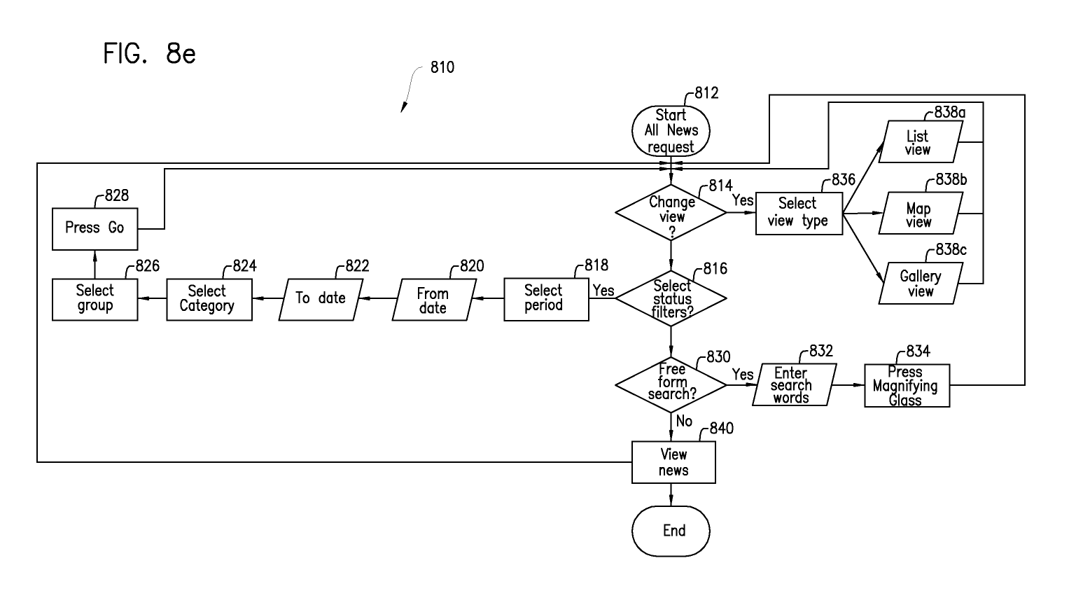

In the world of citizen reporting and the enablement of any field reporter globally to opportunistically submit content for distribution and sales, there is a possibility that the result can be a large percentage of low value or low interest items that can make it challenging for content requesters to sort through that content to find items of value or use to them. In some implementations, the current subject matter can be configured to provide various sorting, filtering, and view options to the content requester. Such views can include a list view (as shown in FIG. 8a), which can be a table information column view of the media items, a map view (as shown in FIG. 8b), which can be a geographic map view of a location where each media item was captured, a gallery view (as shown in FIG. 8c), which can display a small thumbnail of all media items meeting a predefined search criteria. In the map view, a user can define a geographic map area to limit their search of displayed items. The user can define an area of interest on the map about which media items can be searched and delivered to the user.

In some implementations, the content can be searched and filtered using at least one of the following options. The content can be searched based on channels, using which a user can predefine multiple advanced search criteria under a single defined saved channel. The saved channels can be utilized to filter a list of found media items to only items that fit specific search criteria. The channels are discussed in more detail below. Further, some basic filters can be used to search for content, where such filters can include a type of content, i.e., video, image, audio, etc. The content can be searched by a particular date range, which can limit display of media items created within a specific date window. A geographic area filter can be used to define a specific area on the map that contains desired media items. Additionally, a search can be conducted based on a text search across all available metadata text fields in search of items that contain the specified search words. In this case, search criteria can include at least one of the following: item title, description, category, keywords, audio transcription, etc. In some implementations, the current subject matter can be configured to filter content in real time as it is being supplied and arrange to have it placed in an appropriate channel or allocate it in any other desired way. The real time filtering can be performed based any predetermined filtering parameters. Some implementations of the current subject matter can be configured to search, filter, retrieve, and/or otherwise find content in one and/or more real time content, existing content, archived content, and/or any other type of content, and/or various combinations thereof.

After searching and filtering, the media content can be selected by and displayed to the user. The media content can be displayed in various formats, including a small thumbnail view, a detailed item view containing all the relevant metadata. An exemplary media content display is illustrated in FIG. 8d.

FIG. 8e is an exemplary flowchart illustrating method 810 for managing media content information, according to some implementations of the current subject matter. FIG. 8e illustrates method 810 with regard to obtaining news information as media content. Any other content can be managed using method 810. At 812, the management of news content can be initiated. At 814, a view can be changed based on a desired view type (at 836), which can include a list view (at 838a), a map view (at 838b), a gallery view (at 838c), as discussed above. Once the view is selected, status filters can be selected, at 816. Such status filters include a particular time period beginning at a predetermined start date and ending on a predetermined end date, a predetermined category of news, a grouping of news, and once such selections are made, the filters can be applied, at 818-828. Once the filters are selected or if no filters are desired, a free form search can be performed, at 830, as discussed above. The search can use various keywords, at 832, and certain items can be enlarged for better view using a “magnifying glass” software option, at 834. Once such selections, filtering, and searching is applied, the desired news content can be displayed, at 840.

As stated above, channels can be configured to define advanced search criteria for filtering through a pool of previously submitted media and/or providing immediate notifications when new submissions match a predefined search criterion. This can be accomplished through use of multiple search criteria as specific line items can combined using Boolean logic (AND, OR) on each defined search line item. This can allow the user the power and flexibility to not only create but save repeatable complex searches for use in subsequent searches and new content.

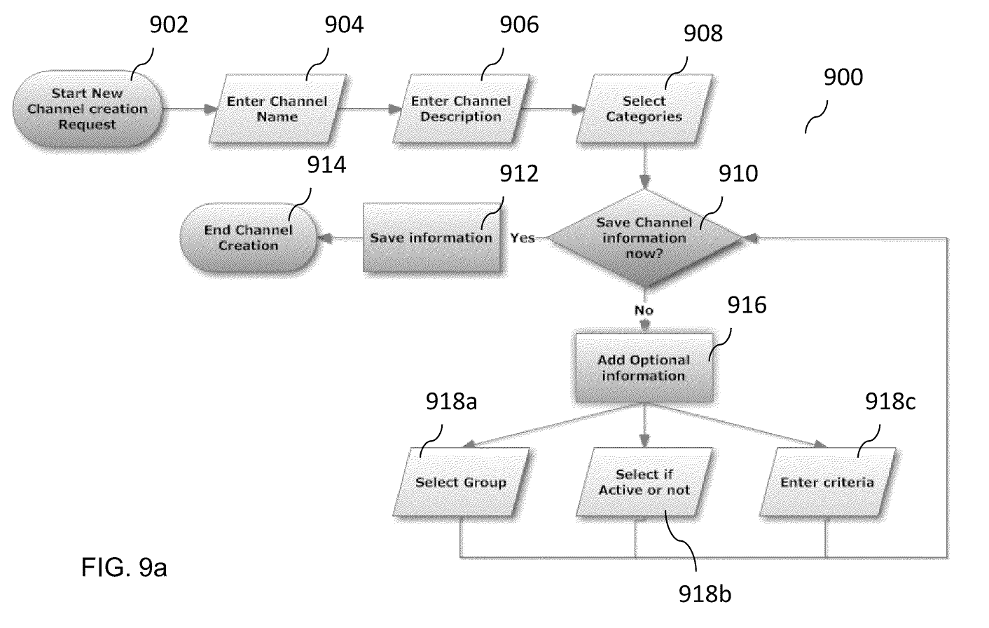

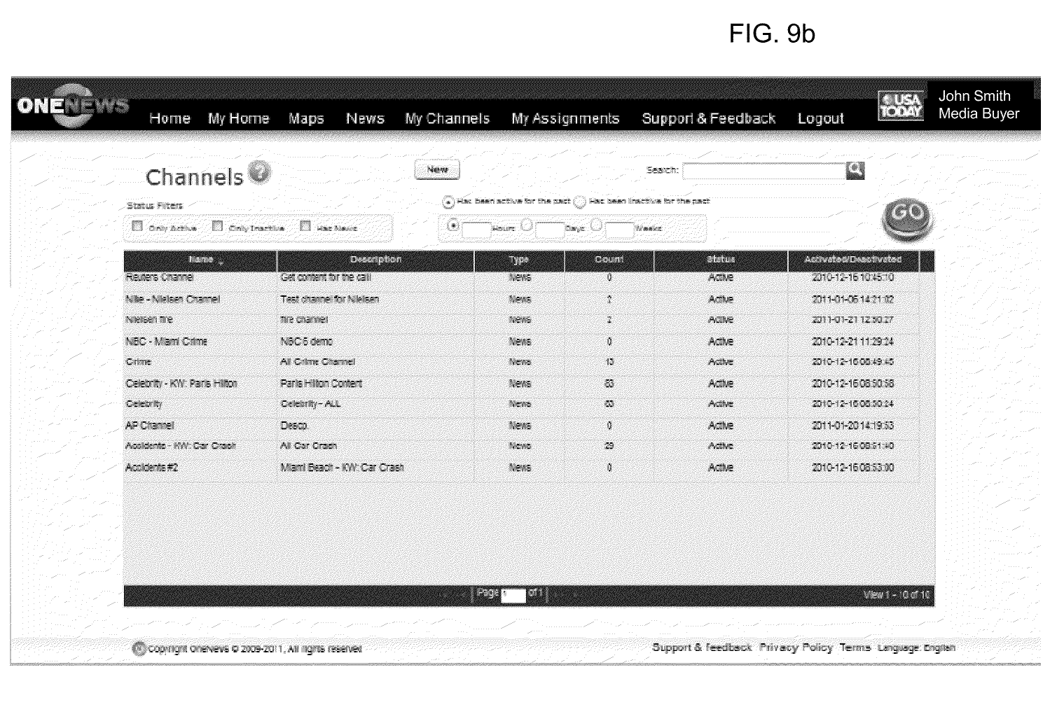

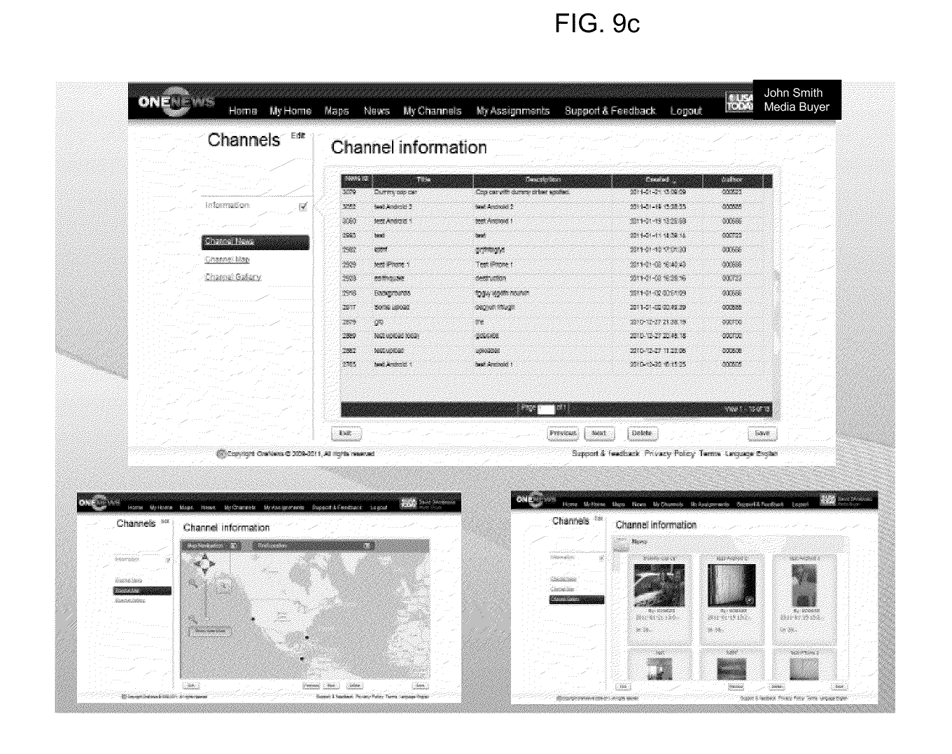

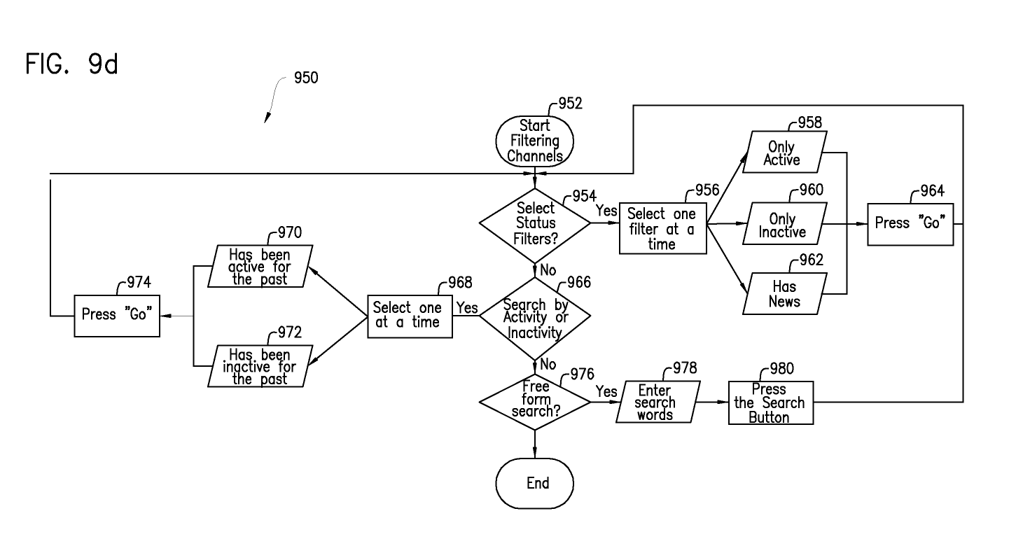

FIG. 9a is a flowchart illustrating an exemplary method 900 for creating a channel, according to some implementations of the current subject matter. At 902, a new channel request can be initiated. A channel name, description, and content categories can be entered, at 904-908. Such entry of information can be accomplished a media buyer and/or a content requester user interface. Channel information can be saved, at 910-912, which can include channel creation, at 914. If additional information (e.g., filtering, searching, grouping criteria, etc.) is desired to be entered for the channel, the user can enter such information, at 916. The information can include at least one of the following: selection of a group (at 918a), selection of an active status (at 918b), criteria (e.g., search, filtering, etc.) (at 918c).

In some implementations, channels can be configured to include filtering preferences so that the content that is of value and interest to the content requester is displayed. Channels can enable content requesters to filter through and discard lower value and non-relevant content and to find and review valuable and/or desired content. Channels can be also configured to include notification preferences that can compare newly submitted content from a reporter against a predefined search criterion, and if there is a match, can notify the content requester in accordance with notification preferences of the requester. This can insure that the content requester is immediately made aware of any breaking news events as soon as they happen.

FIGS. 9b-9c are exemplary user interfaces that illustrate various channels being created according to predetermined criteria (e.g., crime, celebrity, etc.). Channels can be displayed in categories view, map view, and/or thumbnail view, as shown in FIG. 9c. The channels can also be searched and/or filtered using categories, keywords, locations, etc. FIG. 9d is a flowchart illustrating an exemplary method 950 for filtering channels in accordance with various user preferences, according to some implementations of the current subject matter. At 952, channel filtering can be initiated. A channel filter status can be selected, at 954. Channel filters can be selected one at a time or more than one at a time, at 956, and include “only active” filters (at 958), “only inactive” filters (at 960), and filters that have news (at 962). Upon selection of filters, the user can apply those to select particular channels of interest, at 964. Once the filters are selected or if no filters are desired, the channels can be searched by activity or inactivity, e.g., whether content is submitted for those channels, at 966. If such search is desired, channels can be selected one at a time or more than one at a time, at 968, and a determination is made that some channels have been active for a predetermined period of time, at 970, or have been inactive for a period of time, at 972. Once, such channels are identified, they can be appropriately selected, at 974. Once such search (at 966) is performed or if no such search is desired, a free-form search of channels can be conducted, at 976. This search is conducted using various keywords or other search categories, at 978-980. Other ways of filtering channels are possible.

In some implementations, the content requester and/or media buyers can create assignments, which can request a particular content to be obtained by a reporter. The assignments can be directed to a general audience of reporters or a particular reporter or a group of reporters. Alternatively, the content requesters can select a reporter based on reporter's location with regard to a particular content (e.g., a country, state, city, street, zip code, address, building, an event, an occurrence, etc.), skills of the reporter (e.g., professional camera operator, photographer, news reporter, professional athlete, government field agent, corporate investigator, etc.), reporter's possession of a particular equipment (e.g., a type of camera, mobile device, audio/video equipment, vehicle, etc.), reporter's interests, affiliations, hobbies, and/or other factors and/or a combination thereof. Content requesters can locate and direct any reporter to a specific event within seconds of knowing of that event. If that reporter is already on-site, the reporter can stream (e.g., video, audio, etc.) the content to the content requester substantially immediately. This can be accomplished through, for example, sharing of GPS location information of the reporter upon request. In some implementations, content requester can also be presented with a map that illustrates all reporters that are located proximate to the desired content-generating event. Then, the content requester can select a particular reporter or a plurality of reporters for obtaining and providing such content to the content requester.

After a reporter has viewed and accepted an assignment request, the reporter can proceed to the location of the content-generating event and follow detailed instructions in the assignment to obtain the desired content. The content requester can be provided with a user interface that can allow the requester to view in real time the content being acquired by the selected reporter. This can be useful, for example, in providing breaking news to a newsroom substantially in real time as events occur.

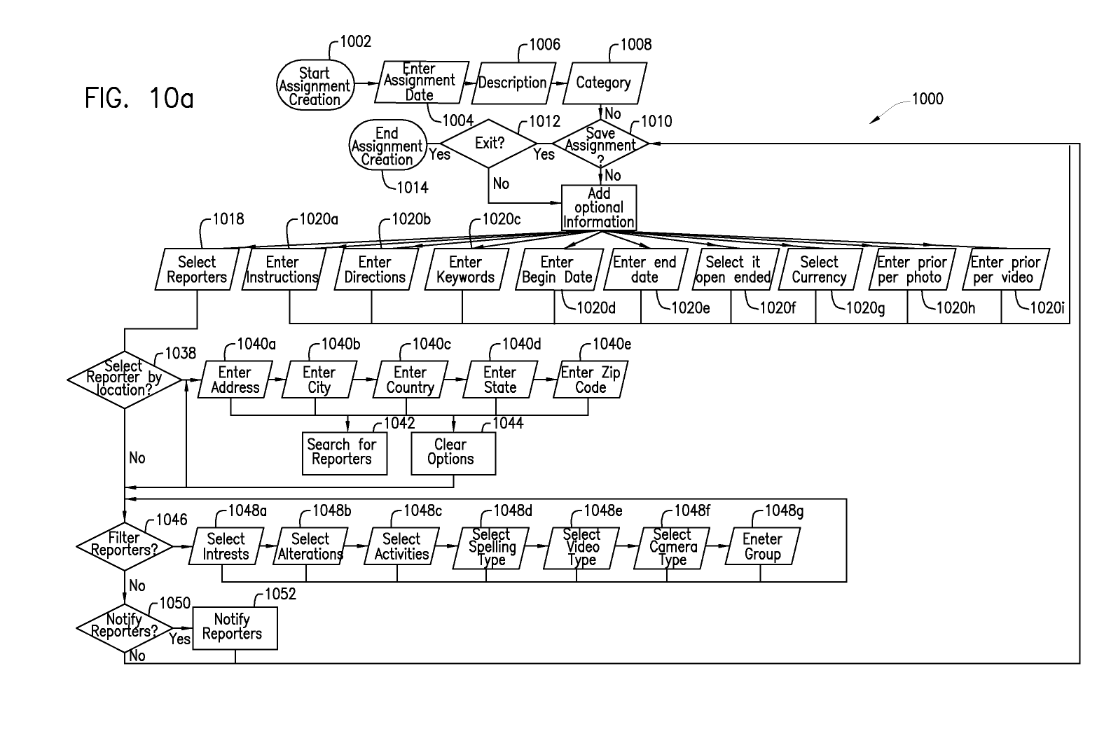

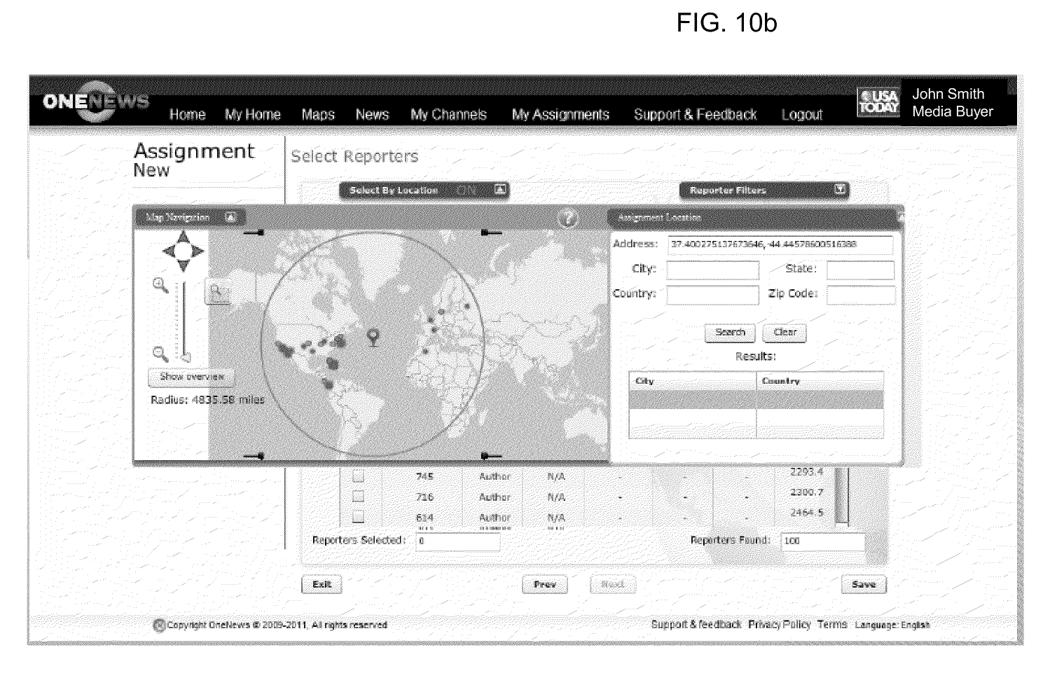

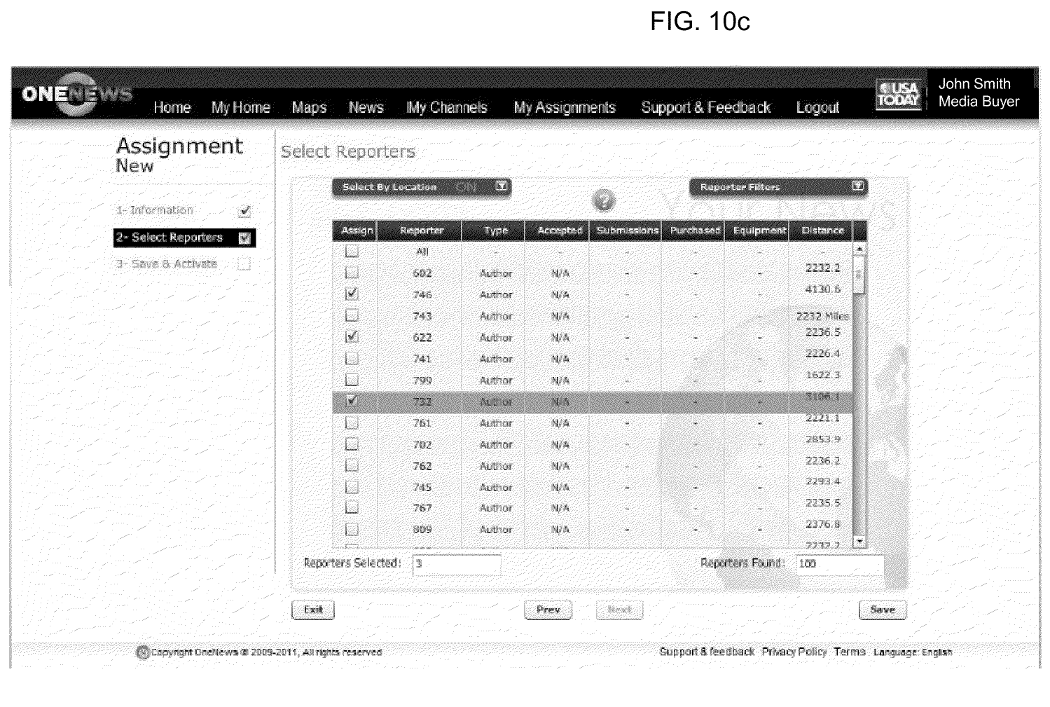

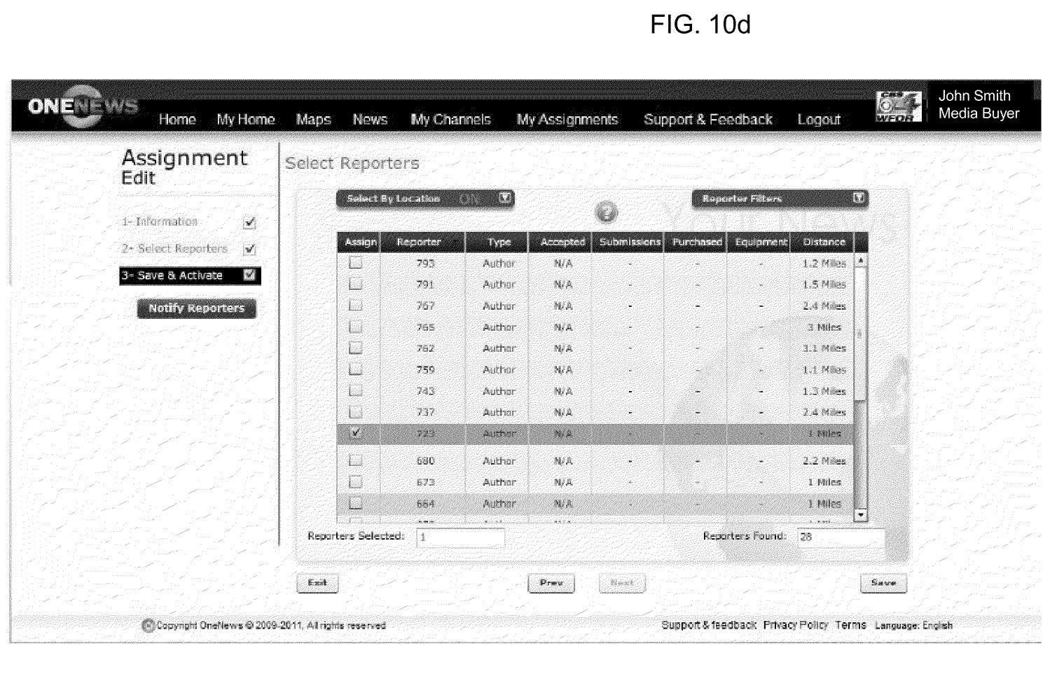

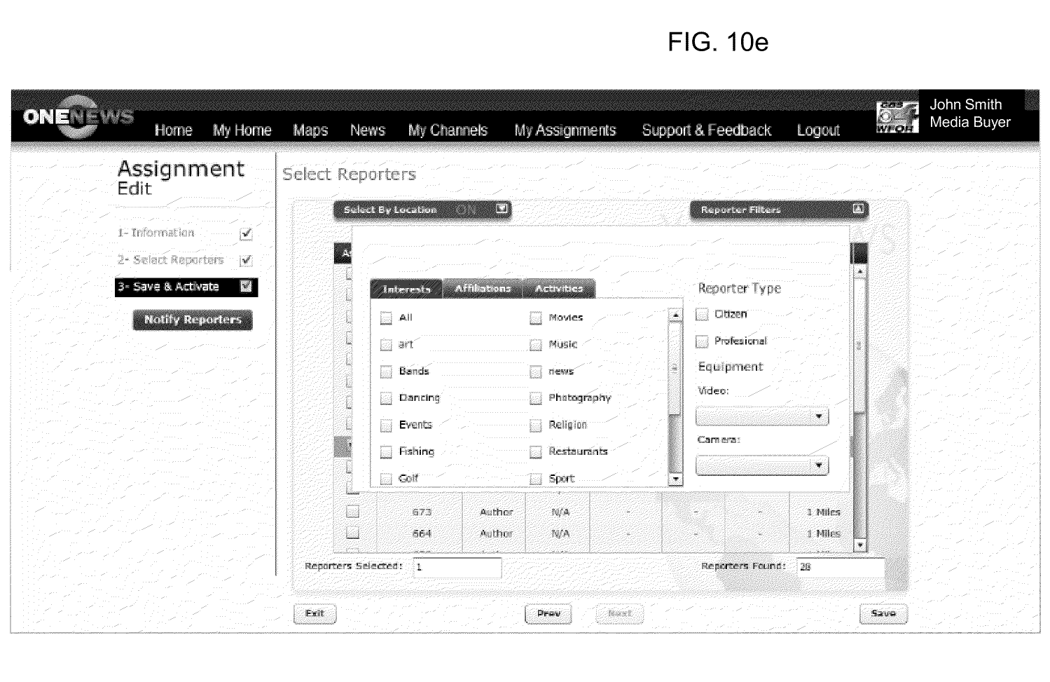

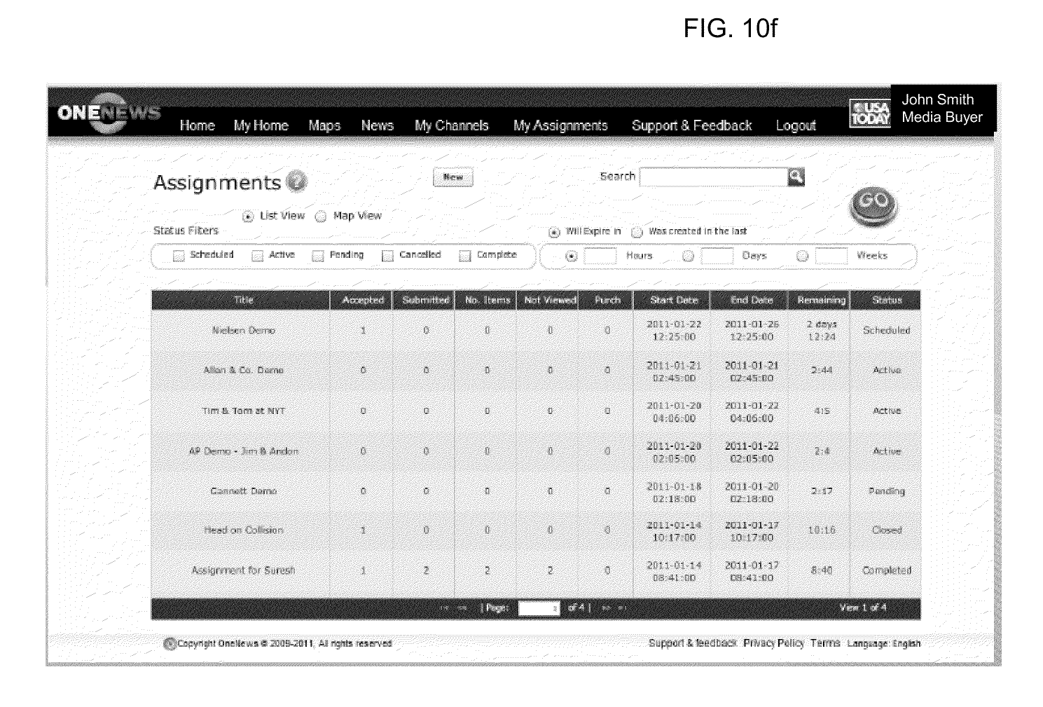

FIG. 10a is a flowchart illustrating an exemplary method 1000 for creating an assignment. At 1002, assignment creation can be initiated. Then, the assignment name or title can be created, at 1004. The title of the assignment can be descriptive of the request (e.g., “celebrities sightings at charity gala”) or a can be coded to protect nature of the assignment. For example, protection of the nature of the assignment as well as content obtained may be desired by various government organizations, police investigating a crime, medical organizations seeking to comply with various Health Insurance Portability and Accountability Act (“HIPAA”) standards, etc. At 1006, the description of the assignment can be entered. For example, the description can state: “obtain photographs, video and/or audio recordings of celebrities attending charitable event organized by ABC Company at 123 Main Street ballroom”. The description can be as specific as can be desired by the entity requesting the content. Alternatively, the assignment description can be cryptic/written in a particular code in order to hide sensitive nature of the information being sought. Once the description of the assignment is entered, the assignment can be placed in a particular category (see, for example, Table 1 above), at 1008. The assignment can be placed into one or more content categories, which can allow access of the obtained content by different content buyers using different searching methods. At 1010, the assignment can be saved. Then, the assignment creation process can end, at 1012-1014. However, if further information is desired to be entered, additional information concerning the assignment can be added, at 1016. Such information can include selection of reporters (at 1018), entry of instructions for obtaining content (at 1020a), entry of directions to the location where content acquisition may be desired (at 1020b), entry of various keywords (at 1020c), entry of begin date (at 1020d) and/or end date (at 1020e) during acquisition of content is desired or during which assignment is valid, indication (at 10200 that the assignment is open-ended indicating that the originator of content can provide content upon its acquisition on a continuous basis, selection of currency for payment to the content originator (at 1020g), entry of a price per piece of content (e.g., photograph, video, audio) that is obtained by the originator (at 1020h and 1020i). Assignment can also contain any other information that may facilitate or otherwise supplement information concerning the assignment.

Selection of content originators/reporters can be accomplished based on various factors. For example, selection of the content originators/reporters can be accomplished based on their location, at 1038. Location can be determined based upon entry of at least one of the following information: an address (at 1040a), city (at 1040b), country (at 1040c), state (at 1040d), zip code (at 1040e), an intersection of streets, a nearby location (e.g., a name of a business, a name of a professional office, a name of a pharmacy, an airport, a train station, a billboard, etc.), etc. In some implementations, various coordinate data can be provided (e.g., GPS coordinates) to determine location of reporters. Based on the entry of the location information, the system can search for reporters whose location can match the entered information, at 1042. Alternatively, the entered information can be cleared, at 1044, if it is no longer desired to search for reporters by location or no reporters can be found based on the entered location information.

If location-based searching for reporters is not desired, reporters can be filtered, at 1046. Filtering can be accomplished based on at least one of the following: reporter interests (at 1048a), reporter affiliations (at 1048b), reporter activities (at 1048c), reporter type (at 1048d), content type (e.g., video/audio/photo type, resolution, quality etc.) (at 1048e), equipment type (e.g., camera type, device type, etc.) (at 1048f), and/or group information to which particular reporter(s) can belong (at 1048g). Filtering of reporters can be also accomplished based on any other criterion and/or information. Once reporters are filtered and/or selected, the reporters can be notified of the assignment, at 1050-1052. Alternatively, the process 1000 returns to 1010, where a determination can be made again whether or not to save the assignment. The selection and/or filtering of reporters can be performed in any order using any combination of the criteria for filtering/selection.

FIGS. 10b-10d illustrates exemplary user interfaces for selection of reporters for a created assignment based on a particular geographic location that can be provided in the form of GPS coordinates, address, zip code, country, etc. A radius around that location can be defined to determine where potential reporters can be located (on FIG. 10b, reporters are indicated by dots). Once the radius is defined, a listing of reporters can be presented, as shown in FIG. 10c. A list of reporters can be narrowed down to limit the number of reports that may be closer to the location of the content-generating event, as shown in FIG. 10d. Each reporter can be identified y his/her name, identification number, number of submissions, indication whether content was previously purchased from that reporter, type of equipment the reporter may be carrying and distance to the location of the content, and any other information. One or more reporters can be selected for the assignment and upon their acceptance of the assignment, their status can be changed accordingly.

FIG. 10e illustrates an exemplary user interface for selection of reporters based on their interests. Such selection can be done in combination with location information, type of content desired, etc. Alternatively, reporters can be selected based on one factor, e.g., interests only, location only, reporter's equipment only, etc.

FIG. 10f illustrates an exemplary user interface listing all assignments for a particular media buyer. The interface can indicate title of each assignment, whether it has been accepted, how many reporters have accepted it, whether content was submitted, how many pieces of content were submitted, whether media buyer reviewed/purchased the content, duration of the assignment, how much time remains until assignment expires, and assignment current status (e.g., open, closed, pending, completed, etc.).

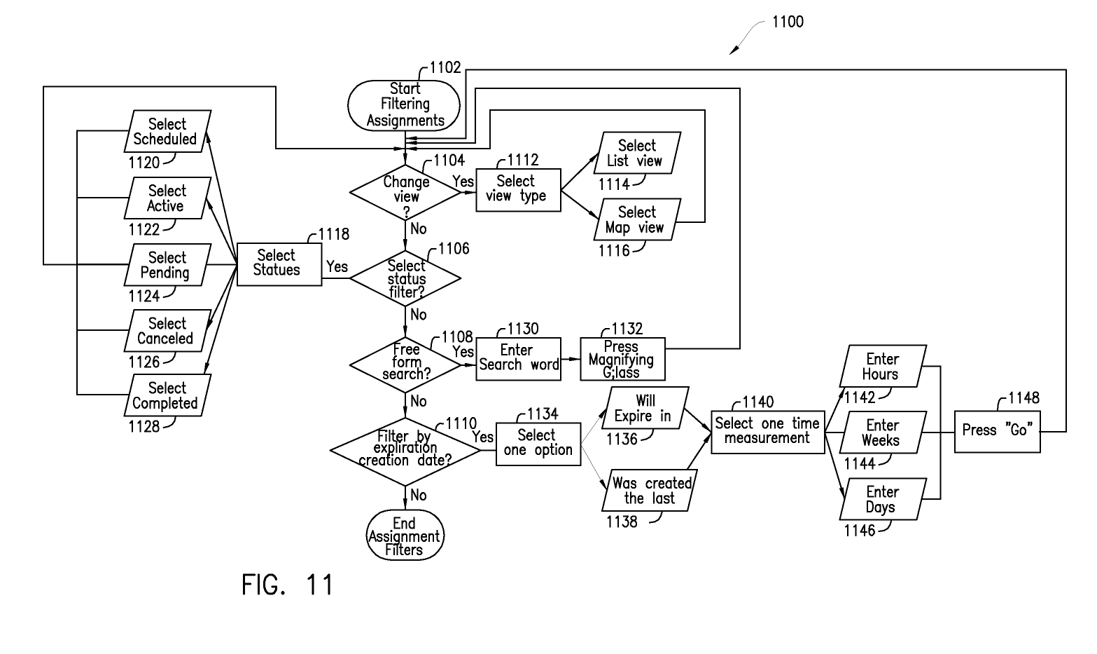

FIG. 11 illustrates an exemplary method 1100 for filtering assignments that can be used by a media buyer or a requester to determine status of each assignment and/or find assignments and any content associated with them, according to some implementations of the current subject matter. At 1102, assignment filtering can be initiated. A particular user interface view of assignments can be selected, at 1104, which can be based on a type of view, e.g., a list view and/or a map view, at 1112-1116. Once a particular view is selected or if no specific view is desired, assignment status filters can be selected, at 1106. The selected status can include “scheduled” (at 1120) indicating that an assignment has been scheduled for distribution to reporters, “active” (at 1122) indicating that an assignment has been provided to reporters and the reporters can submit, are submitting, or have submitted content for it, “pending” (at 1124) indicating that reporters are submitting content for that assignment, “cancelled” (at 1126) indicating that content for that assignment is no longer desired and that it has been cancelled, “completed” (at 1128) indicating that content has been submitted for that assignment and no further content can be submitted. Once the filters are selected or if no filters are desired, a free form search can be performed, at 1108, using keywords, at 1130, and a “magnifying glass” software option can be used to view detailed information about located assignments, at 1132. Further, assignments can also be filtered by their creation and/or expiration dates, at 1110. The assignments can be filters using either or both dates, using a particular time measurement criteria, such as hours, days, weeks, months, years, etc., at 1134-1146. Once all or no filters are applied, the assignments are searched and filtered, at 1148, thereby generating results.

In some implementations, assignments can be designated by the content requestor/media buyer and can trigger an auto call-back to the reporter. This can allow content requester/media buyer to check a box during the time of creation of the Assignment which can trigger an automatic pre-recorded or a live call-back to the reporter. An example of the call-back message can be as follows: “Thank you for uploading content to XYZ Corp. Please dictate information about what you witnessed.” The call back feature can be controlled by the content requester/media buyer at the time of creating/issuing the assignment. In some implementations, a unique call back message can be triggered based upon submission of a content by the reporter. Here, the content requester/media buyer can record a unique outbound message to the reporter at the time of assignment which can be used in the call-back. For example, BMW might say “Thank you for uploading content about the new BMW X-7. Please tell us what you like most about the vehicle. If your recording is used in a promotional campaign, we will pay your $250.” The audio file dictated by the content requester/media buyer can be automatically transcribed to text and appended with the audio file to the image.

In some implementations, assignments can be configured to close or end after a certain number of submissions has been reached. For example, the assignment can end after 50 items of content are uploaded. Alternatively, the assignment can be manually cancelled or the assignment can be automatically cancelled after a certain period of time.

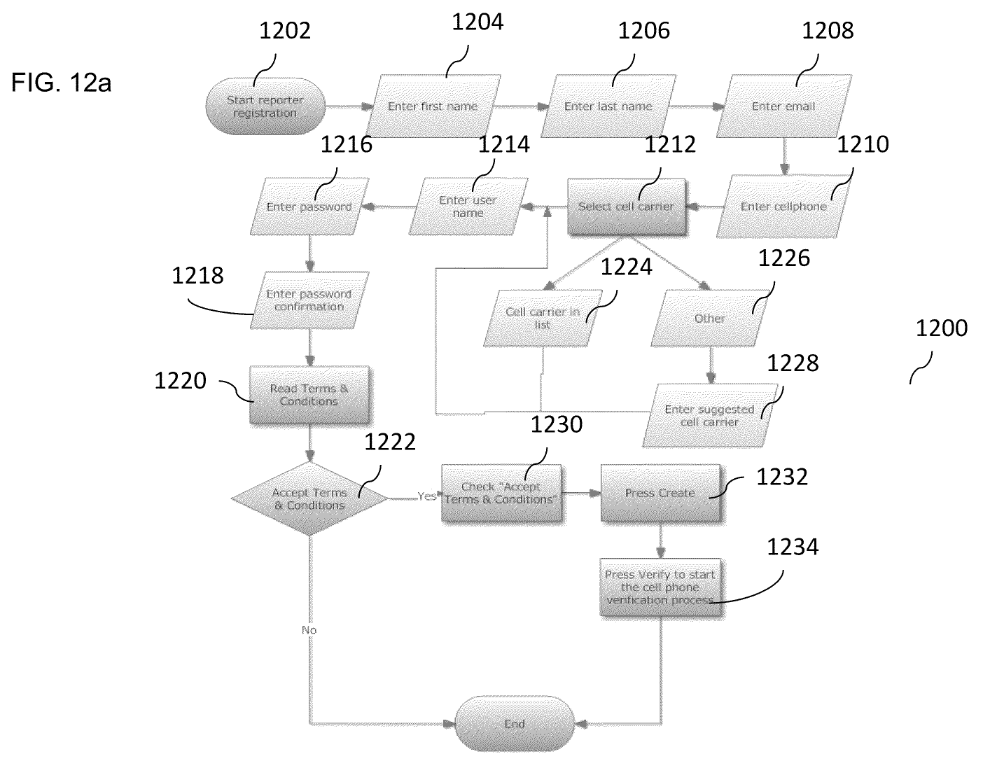

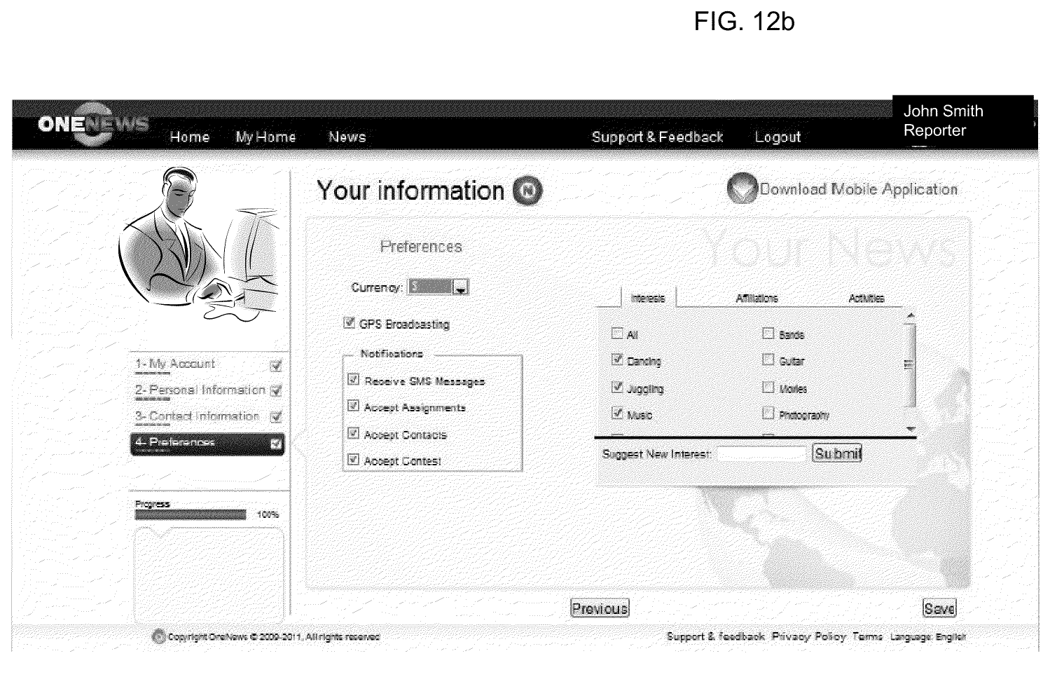

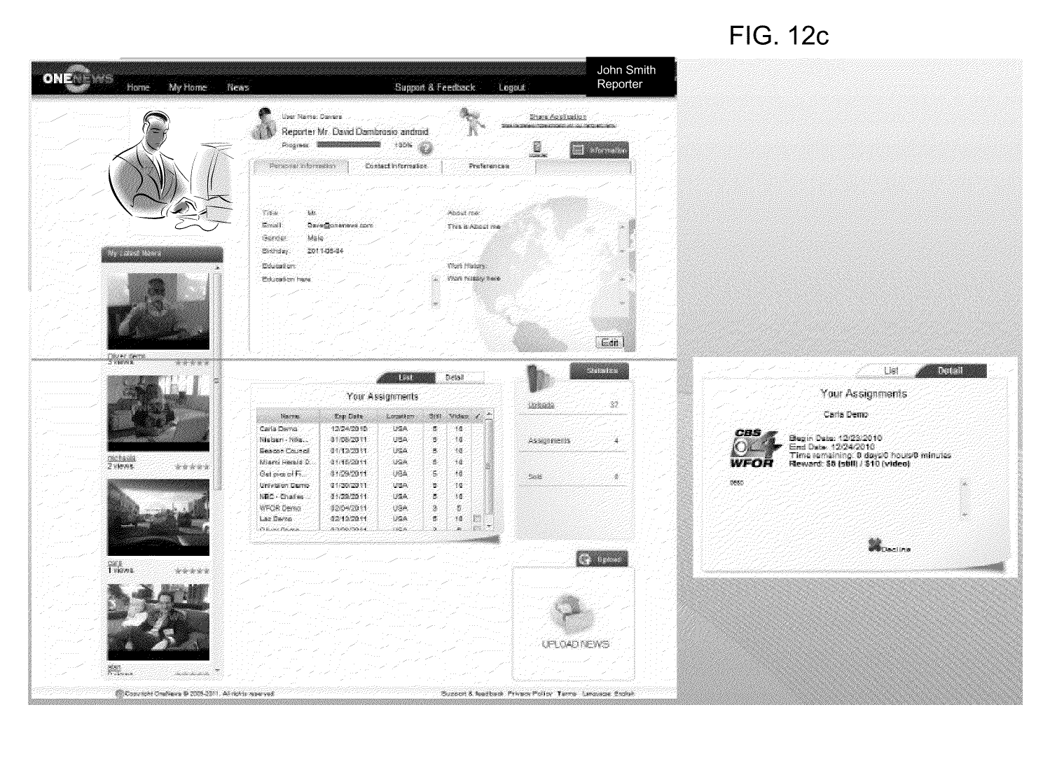

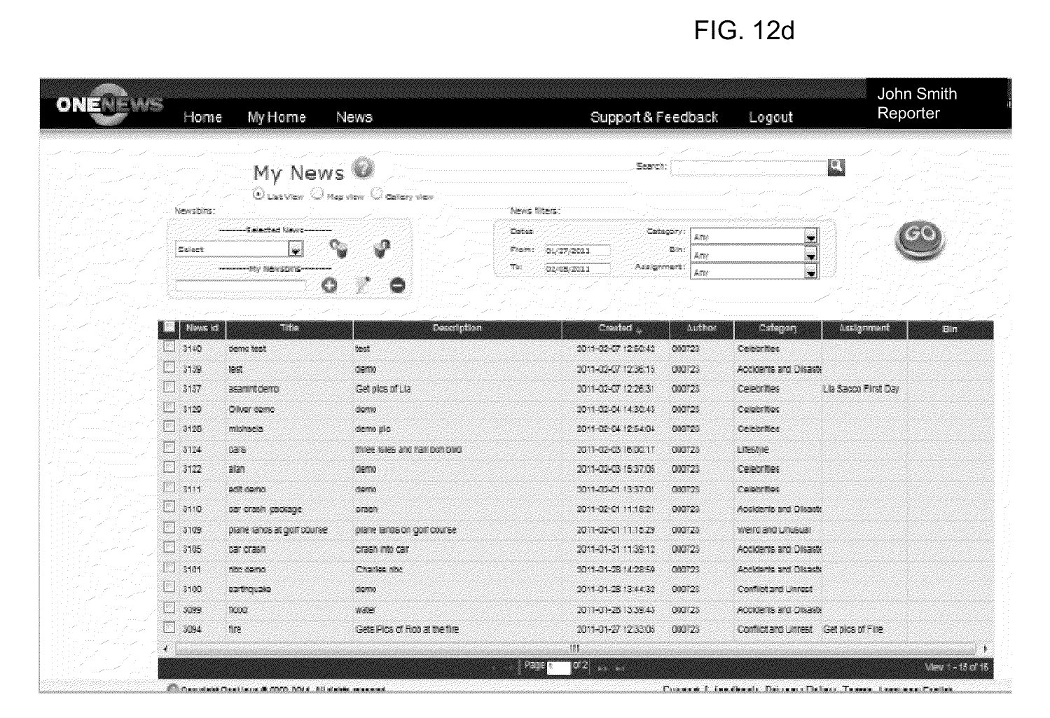

In some implementations, any reporter can be configured to submit content that may be desired by the content requester and/or a media buyer. The reporter can be registered with the system 100 and/or with a particular content requester and/or media buyer and can receive an appropriate compensation/credit for submission of content to that content requester and/or media buyer. FIG. 12a is a flow chart illustrating an exemplary method 1200 for registering a reporter, according to some implementations of the current subject matter. At 1202, reporter registration can be initiated. The reporter can enter his/her first name, last name, email address, a number of reporter's mobile device (e.g., a cellular telephone number), provide a wireless (or other) communications carrier for the reporter's mobile communications device, and enter/confirm username and password, at 1204-1218. In some implementations, the system can be configured to determine whether the entered wireless communications carrier is in the list that can be maintained at the repository 108 (as shown in FIG. 1), at 1224. If the carrier is not in the list, the reporter can be prompted to enter the carrier for his/her mobile communications device, at 1226-1228. After accepting appropriate terms and conditions, at 1222, 1230, a reporter's account is created, at 1232, and the mobile communications device is verified with the system 100, at 1234, for the purposes of determining whether communication can be established with that device.

FIGS. 12b-12d illustrate exemplary user interfaces that can be associated with a created reporter account. Reporters can logon to their account to update their profile information and preferences (FIG. 12b), complete training to improve their ranking in the eyes of the content requesters/media buyers, review of their financial transactions, and view and update any submitted media, as well as any other options (FIGS. 12c-d). In some implementations, reporters can upload content directly from their computers and/or mobile devices. The content can be a high-resolution content along with requisite metadata and commentary (e.g., text, graphics, etc.). The reporter's user interface's assignment section can display a table list of all assignments that the reporter was selected for. This can include both assignments the reporter accepted and did not participate on. The reporter can see all media submitted per each assignment, the items actually purchased and the content requester/media buyer that created the assignment.

Also, it may be in the best interests of reporters to present themselves in the best possible light to the content requester/media buyers to assist in improving their overall chances of being selected for assignments. In some implementations, a content requester/media buyer can review reporter's profile information to determine whether or not that reporter can be selected. The selection of a reporter can done based on presence of a profile picture, which can be used when crediting reporter with a particular content, various personal information, interests that can include intellectual interests, sports, etc., affiliations that can be professional and non-professional affiliations that each reporter can be associated with or participating in, activities that can include sports, lifestyle activities, etc., reporter's skills and professional training, work history that can include a list of previous journalistic submissions or other professional reporting skills and abilities, samples of prior work, type of equipment used (e.g., video camera, photographic equipment, mobile device, etc.), reporter ranking, reporter identity that can be hidden or exposed to the content requester/media buyer, and/or other factors and/or combination thereof.

In some implementations, a reporter can be assigned a particular ranking level. The ranking can be determined by a particular content requester/media buyer and can measure an experience level and a chance for success of selecting that specific reporter for an assignment or in qualifying the reporter as a valid source. To determine reporter ranking, various information can be used, including at least one of the following: a historical submission history, best submitted items, any negative feedback that may have been submitted by other content requesters/media buyers, etc. Reporter rankings can be also based on at least one of the following: reporter training certification that can indicate whether the reporter completed a particular certification course offered by the content requester/media buyer to improve reporter's skills and therefore ranking level, professional experience that can include a list of previously published accomplishments, and samples for review of some of their published media, content requester/media buyer history of content submission that has been done by the reporter, e.g., number of submissions, quality of submissions, purchased items, etc., a number of successfully completed assignments by the reporter, as well as, other factors.

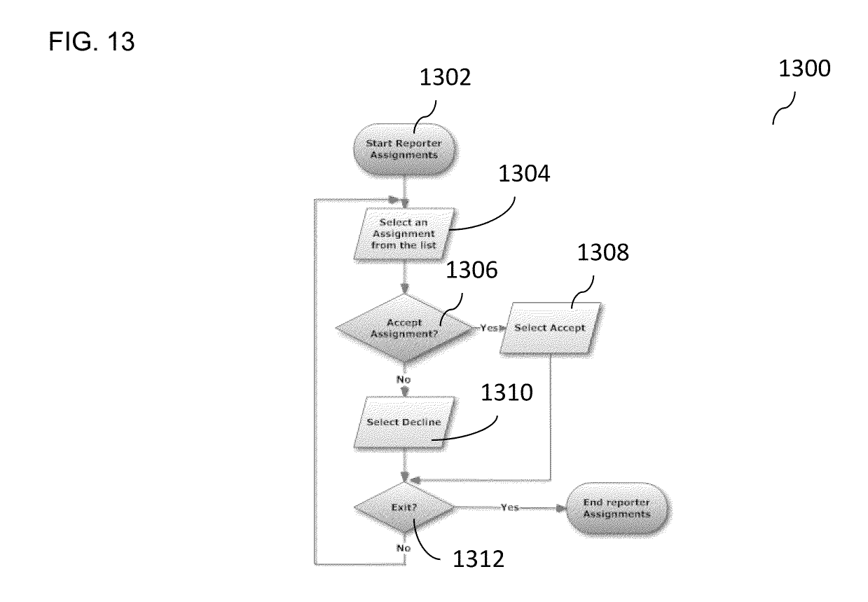

In some implementations, once the reporters are selected for a particular assignment by the content requester/media buyer, the reporters can elect whether or not accept or decline an assignment, as shown in FIG. 13. FIG. 13 is a flowchart illustrating an exemplary method for performing assignment acceptance/decline by the reporter, according to some implementations of the current subject matter. At 1302, a reporter assignment is initiated, which can be performed by a content requester/media buyer contacting a reporter and providing a reporter with at least one assignment containing an offer to obtain a particular content for that content requester/media buyer for a particular compensation. At 1304, the reporter can select a particular assignment from the list. Then, the reporter can choose to accept the assignment, at 1306-1308, or decline it, at 1310. At that point, the reporter can choose to end selection of assignments or look for other assignments, at 1312.

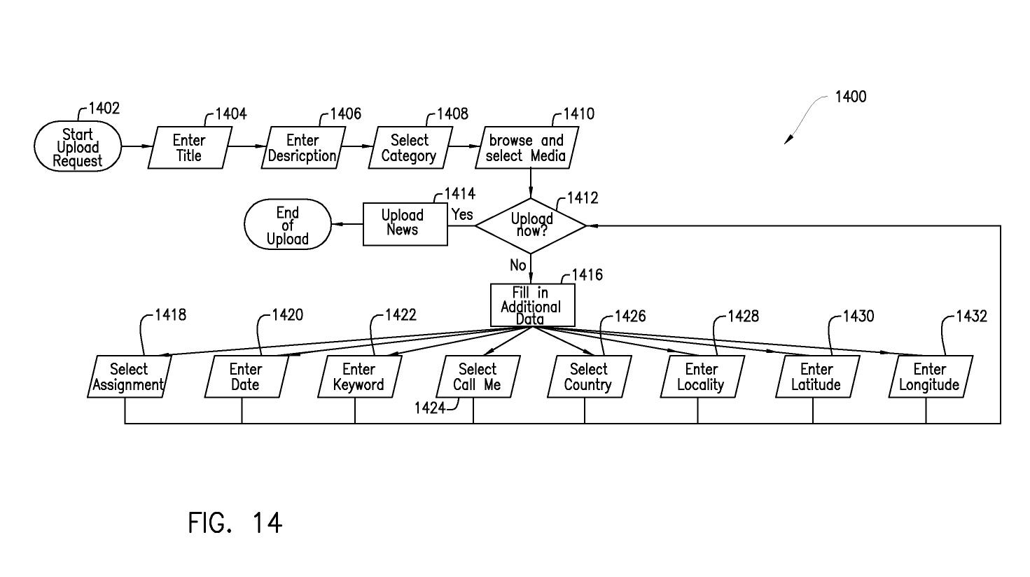

Once the reporter accepted an assignment, the reporter can proceed to obtain content that has been requested by the content requester/media buyer in the assignment. After obtaining the content, the reporter can upload it to the content requester/media buyer and/or content repository 108 (as shown in FIG. 1). FIG. 14 is a flowchart that illustrates an exemplary method 1400 for uploading content by a reporter, according to some implementations of the current subject matter. The uploading can be performed from a variety of reporter's devices (e.g., mobile devices, personal computer devices, smartphone devices, iPad, iPod, iPhone, PALM devices, etc.). At 1402, an upload request is submitted by the reporter for uploading a particular content. Such content can be specifically requested by the content requester/media buyer or alternatively can be uploaded by the reporter without a request. The reporter can enter title, description, select category and add any desired media, at 1404-1410. Then, the reporter can determine whether or not to upload the content, at 1412. If so, the content is uploaded, at 1414. Otherwise, the reporter can include any additional information or data that the reporter may wish to add, at 1416. Such information can include a selection of a particular assignment for which content is being uploaded, entry of a particular date, keywords, selection of a “call me” feature whereby the reporter can request a call from the content requester/media buyer, as well as entry of various geographical information (country, locality, latitude, longitude, etc.), at 1418-1432.

The uploaded content can be included in a submission package, whereby the reporter can pick one of several media items stored on their device and package such media along with a content as a single submission using common metadata. This can save time on the part of the reporter and optimize the review by the content requester/media buyer. The reporter can also include a detailed story line with the submission package to increase an overall value of the content as well as increase the likelihood of a successful sale.

In some implementations, reporters can submit content (e.g., news, photographs, videos, audio files, etc.) along with various information and/or metadata. Such information can include metadata, such as title, category and/or keywords, etc. that can be used to identify content and/or link it with other content. Reporters can also submit audio/video tags, e.g., a recorded video/audio description of at least a portion of the content. This can be delivered through an automated call-back mechanism and promoted by an automated voice response system that can ask the reporter to dictate what he or she witnessed. All video/audio included with the media submission can be automatically converted to text data and can be searchable by any content requester/media buyer. In some implementations, video audio and individual audio tags can be automatically converted to searchable text data thereby creating an ever expanding library of searchable keywords for filtering live content feeds. This can expand the richness of the metadata set associated to any media item increasing the chances for valuable content to be successfully found. The reporters can also add files or other information in connection with the uploaded content. This can include media taken with a camera or transferred to a storage of reporter's device. In some implementations, if the reporter is using a camera phone or another phone camera application that opportunistically captures an event of value, the reporter can have the option to submit this content to the content requester/media buyer for publication, distribution and/or sale.

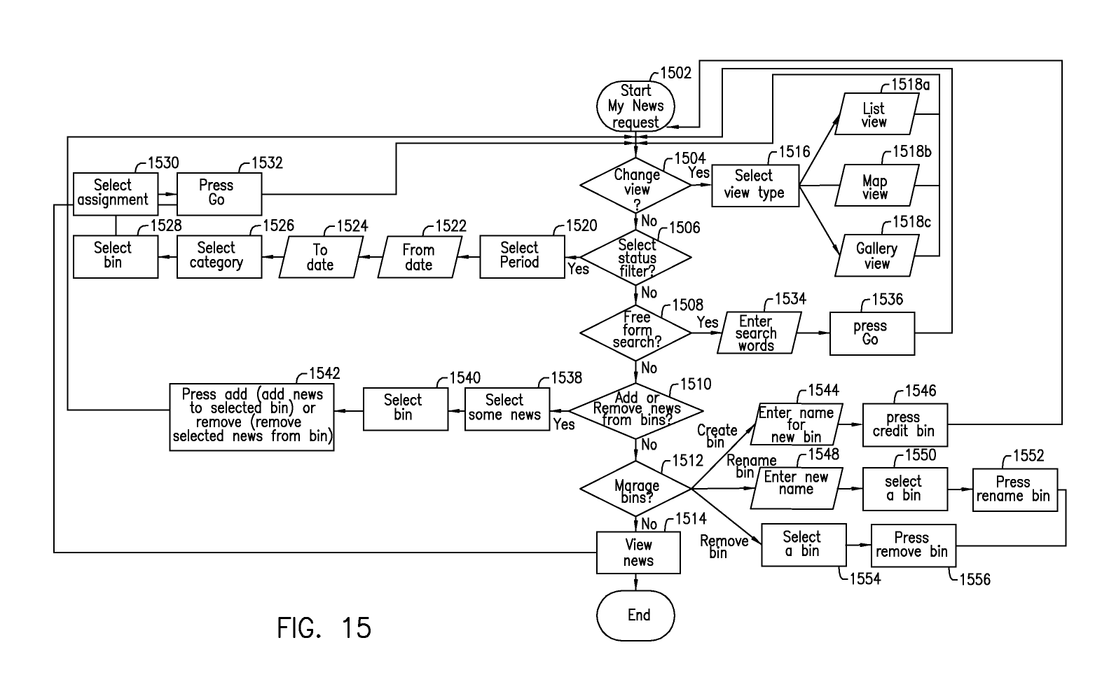

In some implementations, reporters can view any of their previously submitted media, either submitted independently or through the engagement of an assignment. Reporters can share their media postings to their reporter profile pages as one of their “best”, as well as linking their profiles and submitted content to social networking websites, such as Facebook, Twitter, LinkedIn, etc. There are number of filtering, searching and organizational options that can be available for media management, and the ability to search and find specific media items. These can include an ability to create organization bins, so as to package up media for story centric and more complete submissions, and as a basic organizational tool of their ever growing pool of media. FIG. 15 is a flowchart illustrating an exemplary method 1500 for managing reporter's content, according to some implementations of the current subject matter. At 1502, the method 1500 can be initiated and the reporter can be allowed to view all of the reporter's content (e.g., news). The reporter can change the view at 1504 through selection of a particular view (e.g., list, map, gallery, etc.), at 1516-1518(a, b, c). Then, the reporter can select filtering of the submitted content, at 1506. Such filter selection can be performed on the basis of a particular period, “from” date, “to” date, at 1520-1524. Categories of content can also be selected, at 1526, and a bin for those categories can be also selected, at 1528. Using the categories and the bin, a particular assignment can be selected for viewing by the reporter, at 1530-1532. The reporter can also conduct a free form search, at 1508. Such search can be conducted using keywords or any other criteria, at 1534-1536. Content can be also added or removed from bins, at 1510. Addition and/or removal of content can be performed on the basis of particular content as well as a particular bin, at 1538-1542. A bin can be created by the reporter and can contain content that may be relevant to a particular topic, to a particular content requester/media buyer, to a particular category, etc. Bin management can be performed, at 1512, to create, rename, remove, or otherwise manipulate bins containing content. The reporter can create new bins at 1544-1546, rename bins at 1548-1552, or delete bins at 1554-1556. A 1514, the reporter can then view the content that can correspond to the filtering, searching, bin management actions performed by the reporter.

In some implementations, the current subject matter can be further configured to provide a complete revenue sharing model across all participants in the content gathering process, field reporters, stringer networks, contributing content organizations and others. Thus, the current subject matter can support payment to reporters for each item utilized by a content requester/media buyer. The market price for reporter-provided content, especially captured from mobile devices can be predetermined by the content requester/media buyer and/or can be negotiated between the reporter and the content requester/media buyer. The price setting and/or negotiations can take place before the reporter acquires the content or during the time that the reporter is acquiring the content. Thus, content requesters/media buyers can define market pricing for assignment generated content by dictating the price it is willing to pay for each item requested.

In some implementations, the content requester/media buyer can define a dollar price per video, per photo image, per media purchase by the content requester/media buyer for each assignment. This can be communicated to the reporter at the time they review the assignment alert to determine their acceptance of the assignment. In some implementations, the content requester/media buyer can only pay for content that they use, but not for every content item that was submitted.

In some implementations, the content requester/media buyer can directly contact the reporter via telephone, email, short message service (“SMS”), multimedia message service (“MMS”), or any other way in order to validate content source, get additional information, and to provide specific reporter instructions.

In some implementations, a reporter can be automatically contacted based on content requester/media buyer creation of an assignment having a predetermined description, categories, keywords, location, etc. Such assignment can be also automatically created based on a particular chain of events that may be occurring. For example, a content requester/media buyer's system upon receiving information about an “auto accident” can automatically create an assignment, determine at least one particular reporter that would be in a better position to obtain excellent quality content, contact such reporter(s) and request that the reporter(s) obtain desired content relating to “auto accident.” Assignment creation can be also accomplished based on a chain of particular events that may be occurring. For example, reports indicating that looting is happening in downtown area of a city can be generate automatic assignments for any reporters to be on a look out for other looting in that area. This can allow for prediction of a potential area of influence or of any future events that have not occurred yet (e.g., a report of an earthquake can be generate an assignment to be on a look out for a potential tsunami). Further, assignment generation can be accomplished based on a combination of incoming reports and known information or other reports. For example, report of a forest fire in an area combined with particular weather conditions in that area (e.g., easterly wind), can generate an assignment to be on a look out for a potential spreading of a fire in an easterly direction.

In some implementations, assignments can be automatically generated for a reporter based on location of his/her mobile device. Such assignments are not necessarily categorized based on reporter's interests or reporting preference areas. For example, a reporter carrying a mobile device can be located at 123 Main Street and the content requester/media buyer has received reports that there was an accident that occurred at 127 Main Street, a robbery that occurred at 132 Main Street, and a bake sale that is happening at 145 Main Street. The reporter can be given an opportunity to select one or more assignments based on these reports and provide a report to the content requester/media buyer. In some implementations, the assignments can be automatically activated based on a reporter approaching a particular object. For example, a reporter attending an auto show in New York upon approaching an exhibit by BMW can be automatically contacted by BMW (or any other entity wishing to obtain content on BMW) and requested to obtain photographs, videos, and any other content that may be related to reporter's favorite BMW features and/or parts. Upon obtaining such content, the reporter can send such content to the entity requesting the content. Other automatic assignments can be generated based on reporter's location, other assignments and/or events that the reporter may be requested to obtain additional content.

In some implementations, information concerning assignments provided to reporters in various areas can be automatically erased after upload in order to eliminate any digital footprint that may be left on the device, thereby ensuring safety of the reporter. This feature can be useful in areas where oppressive governments monitor all digital communications.

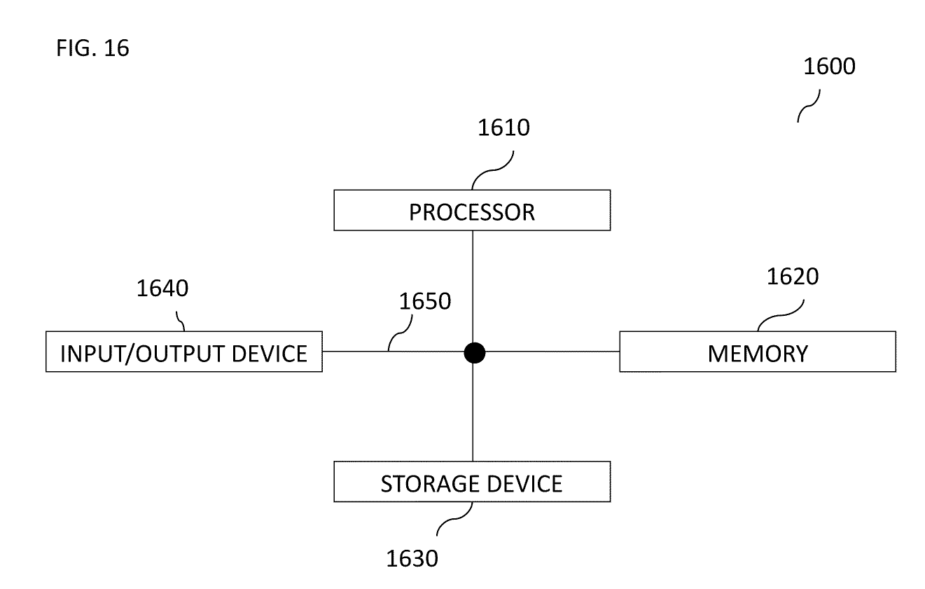

In some implementations, the current subject matter can be configured to be implemented in a system 1600, as shown in FIG. 16. The system 1600 can include a processor 1610, a memory 1620, a storage device 1630, and an input/output device 1640. Each of the components 1610, 1620, 1630 and 1640 can be interconnected using a system bus 1650. The processor 1610 can be configured to process instructions for execution within the system 1600. In some implementations, the processor 1610 can be a single-threaded processor. In alternate implementations, the processor 1610 can be a multi-threaded processor. The processor 1610 can be further configured to process instructions stored in the memory 1620 or on the storage device 1630, including receiving or sending information through the input/output device 1640. The memory 1620 can store information within the system 1600. In some implementations, the memory 1620 can be a computer-readable medium. In alternate implementations, the memory 1620 can be a volatile memory unit. In yet some implementations, the memory 1620 can be a non-volatile memory unit. The storage device 1630 can be capable of providing mass storage for the system 1600. In some implementations, the storage device 1630 can be a computer-readable medium. In alternate implementations, the storage device 1630 can be a floppy disk device, a hard disk device, an optical disk device, a tape device, non-volatile solid state memory, or any other type of storage device. The input/output device 1640 can be configured to provide input/output operations for the system 1600. In some implementations, the input/output device 1640 can include a keyboard and/or pointing device. In alternate implementations, the input/output device 1640 can include a display unit for displaying graphical user interfaces.

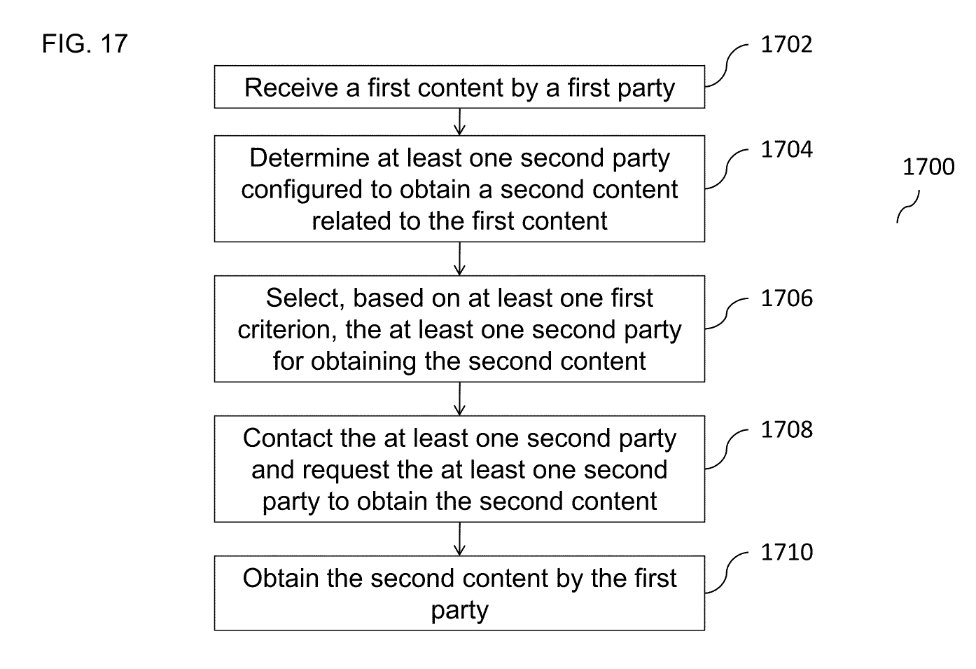

FIG. 17 illustrates an exemplary method 1700, according to some implementations of the current subject matter. At 1702, a first content can be received by a first party. At 1704, at least one second party configured to obtain a second content related to the first content can be determined. At 1706, the at least one second party for obtaining the second content can be selected based on at least one first criterion. At 1708, the at least one second party can be contacted and requested to obtain the second content. At 1710, the second content can be obtained by the first party. The at least one of the receiving, the determining, the selecting, the contacting and the requesting, and the obtaining can be performed on at least one processor.

In some implementations, the current subject matter can include one or more of the following optional features. The determining can include determining the at least one second party based on at least one second criterion. The at least one second criterion can include a geographic location of the at least one second party. The at least one first criterion can include at least one of the following: the geographic location of the at least one second party, a skill of the at least one second party, a history of obtaining content by the at least one second party for the first party, an equipment used by the at least one second party to obtain content for the first party, at least one interest of the at least one second party, and at least one affiliation of the at least one second party. The obtaining the second content can include obtaining the second content by at least one second party. The method can also include determining at least one third party configured to obtain a third content related to the first content, selecting, based on at least one third criterion, the at least one third party for obtaining the third content, contacting the at least one third party and requesting the at least one third party to obtain the third content, and obtaining the third content by the first party. The obtaining the second content can be performed substantially simultaneously in time with the receiving of the first content. The method can also include determining whether to accept the requesting to obtain the second content by the at least one second party, accepting, based on the determining, the requesting to obtain the second content and obtaining the second content by the at least one second party, otherwise, declining, based on the determining, the requesting to obtain the second content. The method can include determining a compensation of the second party for obtaining the second content based at least on the obtained second content and compensating the at least one second party for obtaining the second content. The method can further include providing at least one fourth content together with the obtained second content by the at least one second party to the first party, wherein the at least one fourth content is associated with the second content. In some implementations, the method can include contacting the at least one second party after the at least one second party provided the second content to the first party and requesting the at least one second party to provide the at least one fourth content to the first party. The second content can include at least one of the following: a video recording, an audio recording, an audio/video recording, a photograph, a text transcription, and a multimedia document. The at least one fourth content includes a description of the second content, wherein the description can include at least one of the following: a video recording, an audio recording, an audio/video recording, a photograph, a text transcription, a voice-to-text transcription, a text-to-voice transcription, an Internet document identified by at least one universal resource locator, a computer program, a multimedia document, and a combination of the above. The method can also include determining a future fifth content that can be obtained based on the received first content and at least one sixth content configured to be received by the first party and requesting the at least one second party to obtain the future fifth content. In some implementations, the method can include automatically generating a request to the at least one second party to obtain second content based on at least the received first content.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

The systems and methods disclosed herein can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

As used herein, the term “user” can refer to any entity including a person or a computer.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A method, comprising:
receiving a first content by a first party;
determining at least one second party configured to obtain a second content related to the first content;
selecting, based on at least one first criterion, the at least one second party for obtaining the second content;
contacting the at least one second party and requesting the at least one second party to obtain the second content; and
obtaining the second content by the first party;
wherein the at least one of the receiving, the determining, the selecting, the contacting and the requesting, and the obtaining performed on at least one processor.

2. The method according to claim 1, wherein the determining further comprises determining the at least one second party based on at least one second criterion.

3. The method according to claim 2, wherein the at least one second criterion includes a geographic location of the at least one second party.

4. The method according to claim 3, wherein the at least one first criterion includes at least one of the following: the geographic location of the at least one second party, a skill of the at least one second party, a history of obtaining content by the at least one second party for the first party, an equipment used by the at least one second party to obtain content for the first party, at least one interest of the at least one second party, and at least one affiliation of the at least one second party.

5. The method according to claim 1, wherein the obtaining the second content further comprises obtaining the second content by at least one second party.

6. The method according to claim 1, further comprising
determining at least one third party configured to obtain a third content related to the first content;
selecting, based on at least one third criterion, the at least one third party for obtaining the third content;
contacting the at least one third party and requesting the at least one third party to obtain the third content; and
obtaining the third content by the first party.

7. The method according to claim 1, wherein the obtaining the second content is performed substantially simultaneously in time with the receiving of the first content.

8. The method according to claim 1, further comprising
determining whether to accept the requesting to obtain the second content by the at least one second party;
accepting, based on the determining, the requesting to obtain the second content and obtaining the second content by the at least one second party;
otherwise, declining, based on the determining, the requesting to obtain the second content.

9. The method according to claim 1, further comprising
determining a compensation of the second party for obtaining the second content based at least on the obtained second content; and
compensating the at least one second party for obtaining the second content.

10. The method according to claim 1, further comprising
providing at least one fourth content together with the obtained second content by the at least one second party to the first party;
wherein the at least one fourth content is associated with the second content.

11. The method according to claim 10, further comprising
contacting the at least one second party after the at least one second party provided the second content to the first party;
requesting the at least one second party to provide the at least one fourth content to the first party.

12. The method according to claim 11, wherein the second content includes at least one of the following: a video recording, an audio recording, an audio/video recording, a photograph, a text transcription, and a multimedia document.

13. The method according to claim 12, wherein the at least one fourth content includes a description of the second content;
wherein the description includes at least one of the following: a video recording, an audio recording, an audio/video recording, a photograph, a text transcription, a voice-to-text transcription, a text-to-voice transcription, an Internet document identified by at least one universal resource locator, a computer program, a multimedia document, and a combination of the above.

14. The method according to claim 1, further comprising
determining a future fifth content that can be obtained based on the received first content and at least one sixth content configured to be received by the first party; and
requesting the at least one second party to obtain the future fifth content.

15. The method according to claim 1, further comprising
automatically generating a request to the at least one second party to obtain second content based on at least the received first content.

16. A computer program product comprising a machine-readable medium storing instructions that, when executed by at least one programmable processor, cause the at least one programmable processor to perform operations comprising:
receiving a first content by a first party;
determining at least one second party configured to obtain a second content related to the first content;
selecting, based on at least one first criterion, the at least one second party for obtaining the second content;
contacting the at least one second party and requesting the at least one second party to obtain the second content; and
obtaining the second content by the first party;
wherein the at least one of the receiving, the determining, the selecting, the contacting and the requesting, and the obtaining performed on at least one processor.

17. The computer program product according to claim 16, wherein the determining further comprises determining the at least one second party based on at least one second criterion.

18. The computer program product according to claim 17 wherein the at least one second criterion includes a geographic location of the at least one second party.

19. The computer program product according to claim 18, wherein the at least one first criterion includes at least one of the following: the geographic location of the at least one second party, a skill of the at least one second party, a history of obtaining content by the at least one second party for the first party, an equipment used by the at least one second party to obtain content for the first party, at least one interest of the at least one second party, and at least one affiliation of the at least one second party.

20. The computer program product according to claim 16, wherein the obtaining the second content further comprises obtaining the second content by at least one second party.

21. The computer program product according to claim 16, wherein the operations further comprise
determining at least one third party configured to obtain a third content related to the first content;
selecting, based on at least one third criterion, the at least one third party for obtaining the third content;
contacting the at least one third party and requesting the at least one third party to obtain the third content; and
obtaining the third content by the first party.

22. The computer program product according to claim 16, wherein the obtaining the second content is performed substantially simultaneously in time with the receiving of the first content.

23. The computer program product according to claim 16, wherein the operations further comprise
determining whether to accept the requesting to obtain the second content by the at least one second party;
accepting, based on the determining, the requesting to obtain the second content and obtaining the second content by the at least one second party;
otherwise, declining, based on the determining, the requesting to obtain the second content.

24. The computer program product according to claim 16, wherein the operations further comprise
determining a compensation of the second party for obtaining the second content based at least on the obtained second content; and
compensating the at least one second party for obtaining the second content.

25. The computer program product according to claim 16, wherein the operations further comprise
providing at least one fourth content together with the obtained second content by the at least one second party to the first party;
wherein the at least one fourth content is associated with the second content.

26. The computer program product according to claim 25, wherein the operations further comprise
contacting the at least one second party after the at least one second party provided the second content to the first party;
requesting the at least one second party to provide the at least one fourth content to the first party.

27. The computer program product according to claim 26, wherein the second content includes at least one of the following: a video recording, an audio recording, an audio/video recording, a photograph, a text transcription, and a multimedia document.

28. The computer program product according to claim 27, wherein the at least one fourth content includes a description of the second content;
wherein the description includes at least one of the following: a video recording, an audio recording, an audio/video recording, a photograph, a text transcription, a voice-to-text transcription, a text-to-voice transcription, an Internet document identified by at least one universal resource locator, a computer program, a multimedia document, and a combination of the above.

29. The computer program product according to claim 16, wherein the operations further comprise
determining a future fifth content that can be obtained based on the received first content and at least one sixth content configured to be received by the first party; and
requesting the at least one second party to obtain the future fifth content.

30. The computer program product according to claim 16, wherein the operations further comprise
automatically generating a request to the at least one second party to obtain second content based on at least the received first content.

31. A system comprising:
at least one programmable processor; and
a machine-readable medium storing instructions that, when executed by the at least one programmable processor, cause the at least one programmable processor to perform operations comprising:
receiving a first content by a first party;
determining at least one second party configured to obtain a second content related to the first content;
selecting, based on at least one first criterion, the at least one second party for obtaining the second content;
contacting the at least one second party and requesting the at least one second party to obtain the second content; and
obtaining the second content by the first party;
wherein the at least one of the receiving, the determining, the selecting, the contacting and the requesting, and the obtaining performed on at least one processor.

32. The system according to claim 31, wherein the determining further comprises determining the at least one second party based on at least one second criterion.

33. The system according to claim 32, wherein the at least one second criterion includes a geographic location of the at least one second party.

34. The system according to claim 33, wherein the at least one first criterion includes at least one of the following: the geographic location of the at least one second party, a skill of the at least one second party, a history of obtaining content by the at least one second party for the first party, an equipment used by the at least one second party to obtain content for the first party, at least one interest of the at least one second party, and at least one affiliation of the at least one second party.

35. The system according to claim 31, wherein the obtaining the second content further comprises obtaining the second content by at least one second party.

36. The system according to claim 31, wherein the operations further comprise
determining at least one third party configured to obtain a third content related to the first content;
selecting, based on at least one third criterion, the at least one third party for obtaining the third content;
contacting the at least one third party and requesting the at least one third party to obtain the third content; and
obtaining the third content by the first party.

37. The system according to claim 31, wherein the obtaining the second content is performed substantially simultaneously in time with the receiving of the first content.

38. The system according to claim 31, wherein the operations further comprise
determining whether to accept the requesting to obtain the second content by the at least one second party;
accepting, based on the determining, the requesting to obtain the second content and obtaining the second content by the at least one second party;
otherwise, declining, based on the determining, the requesting to obtain the second content.

39. The system according to claim 31, wherein the operations further comprise
determining a compensation of the second party for obtaining the second content based at least on the obtained second content; and
compensating the at least one second party for obtaining the second content.

40. The system according to claim 31, wherein the operations further comprise
providing at least one fourth content together with the obtained second content by the at least one second party to the first party;
wherein the at least one fourth content is associated with the second content.

41. The system according to claim 40, wherein the operations further comprise
contacting the at least one second party after the at least one second party provided the second content to the first party;
requesting the at least one second party to provide the at least one fourth content to the first party.

42. The system according to claim 41, wherein the second content includes at least one of the following: a video recording, an audio recording, an audio/video recording, a photograph, a text transcription, and a multimedia document.

43. The system according to claim 42, wherein the at least one fourth content includes a description of the second content;
wherein the description includes at least one of the following: a video recording, an audio recording, an audio/video recording, a photograph, a text transcription, a voice-to-text transcription, a text-to-voice transcription, an Internet document identified by at least one universal resource locator, a computer program, a multimedia document, and a combination of the above.

44. The system according to claim 31, wherein the operations further comprise
determining a future fifth content that can be obtained based on the received first content and at least one sixth content configured to be received by the first party; and
requesting the at least one second party to obtain the future fifth content.

45. The system according to claim 31, wherein the operations further comprise
automatically generating a request to the at least one second party to obtain second content based on at least the received first content.
